(19) United States
(12) Patent Application Publication
(10) Pub. No.: US 2026/0289989 A1
(43) Pub. Date: Sep. 24, 2026

(54) SYSTEM

(71) Applicant: SoftBank Group Corp., Tokyo (JP)

(72) Inventor: Rui FANG, Tokyo (JP)

(73) Assignee: SoftBank Group Corp., Tokyo (JP)

(21) Appl. No.: 19/558,432

(22) Filed: Mar. 5, 2026

(30) Foreign Application Priority Data
Mar. 19, 2025 (JP) 2025-044935

(51) Int. Cl. G06V 10/82; G06N 3/0464; G06N 3/0475; G06V 10/26; G06V 10/32; G06V 10/70; G06V 10/764; G06V 10/94

(52) U.S. Cl. CPC G06V 10/82; G06N 3/0464; G06N 3/0475; G06V 10/273; G06V 10/32; G06V 10/764; G06V 10/768; G06V 10/95

(57) ABSTRACT

A system includes a processor that is configured to: periodically acquire images of clothing and store the images in an information processing device; extract features of the clothing based on the stored images; and generate a prompt for instructing a generative artificial intelligence model to propose combinations of the clothing based on the extracted features, and input the prompt to the generative artificial intelligence model.

### CROSS-REFERENCE TO RELATED APPLICATION

This application is based on and claims priority under 35 USC 119 from Japanese Patent Application No. 2025-044935 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional closet management and outfit recommendation systems require a user to manually register clothing items, manually classify attributes such as category, color, and style, and manually select or confirm outfit combinations. As the number of clothing items increases and the user's lifestyle becomes more complex, the burden on the user to manage images, track usage frequency and seasonality, and decide appropriate combinations for each day becomes significant. In addition, even where artificial intelligence is used, many systems merely perform fixed pattern matching or simple recommendation rules, and do not fully exploit generative artificial intelligence models to flexibly create outfit proposals, purchasing suggestions, or disposal and resale strategies. Furthermore, existing systems do not adequately integrate image-based feature extraction of clothing with prompt generation tailored to generative artificial intelligence models, and thus cannot easily adapt to individual user preferences, past selection history, and changes in seasons or trends. Therefore, there is a need for a system that can automatically acquire clothing images, extract clothing features, and generate prompts optimized for generative artificial intelligence models so as to propose clothing combinations, reflect user preferences and past behavior, and support organization and resale of unnecessary clothing items with minimal user effort.

### SUMMARY

In order to solve at least part of the above-described problems, a system according to one aspect of the present invention comprises a processor, wherein the processor is configured to periodically acquire images of clothing and store the images in an information processing device, extract features of the clothing based on the stored images, and generate a prompt for instructing a generative artificial intelligence model to propose combinations of the clothing based on the extracted features, and input the prompt to the generative artificial intelligence model. In this manner, the system automatically converts image-based information of clothing into structured feature data and into prompts suitable for use by the generative artificial intelligence model, thereby enabling flexible generation of outfit proposals without requiring detailed manual input from the user.

In one preferred embodiment, the processor is configured to generate, based on user preferences and past selection history, a prompt for instructing the generative artificial intelligence model to propose optimal combinations of the clothing for a user, and input the prompt to the generative artificial intelligence model. By dynamically reflecting the user's accumulated preferences and selection tendencies in the prompt content, the system enables the generative artificial intelligence model to output clothing combinations that are tailored to the individual user while still leveraging the variety of the user's existing wardrobe. In another preferred embodiment, the processor is configured to determine usage frequency and seasonality of the clothing based on the stored images, generate a prompt for instructing a generative artificial intelligence model to perform organization of unnecessary clothing items and automatic listing of the unnecessary clothing items on a market, and input the prompt to the generative artificial intelligence model. By analyzing when and how often each item has been used and correlating such information with seasonal attributes, the system can automatically identify clothing items that are likely to be unnecessary for the user. The generated prompt causes the generative artificial intelligence model to create instructions or listings for organizing, disposing of, or selling such items on an online marketplace, thereby reducing the user's burden in managing unused clothing and promoting efficient utilization of the user's closet.

The term “system” refers to an arrangement including at least one information processing device and associated hardware and software components that cooperate to execute the processing described in the present disclosure.

The term “processor” refers to any hardware element or combination of hardware elements capable of executing instructions, such as a central processing unit (CPU), a graphics processing unit (GPU), a digital signal processor (DSP), an application-specific integrated circuit (ASIC), a field-programmable gate array (FPGA), or a combination thereof.

The term “information processing device” refers to any device or collection of devices that is capable of storing, processing, and/or transmitting digital information, including but not limited to a server, a cloud computing platform, a personal computer, a smartphone, or a tablet computer.

The term “image” refers to digital data representing visual information, including still images captured by a camera, images obtained from storage, or images generated or processed by the information processing device.

The term “images of clothing” refers to images in which at least one clothing item worn by a person or stored in a closet, wardrobe, or similar environment is visually represented.

The term “clothing” refers to garments and wearable items such as tops, bottoms, outerwear, dresses, suits, shoes, and accessories that are intended to be worn on the human body.

The term “periodically acquire” refers to obtaining data, such as images of clothing, at regular or semi-regular time intervals, which may be defined by a schedule, by user configuration, or by detection of a triggering condition.

The term “store” refers to writing or retaining data, such as images or feature information, in a memory or storage medium, including volatile memory, non-volatile memory, databases, or external storage systems, so that the data can be accessed and processed at a later time.

The term “feature” refers to attribute information derived from images of clothing, including, for example, category, color, pattern, style, seasonality, shape, size, or other properties that characterize the clothing.

The term “extract features” refers to processing images to derive feature information of clothing, using techniques such as image recognition, machine learning, pattern recognition, or rule-based analysis, and converting the images into structured data representing attributes of the clothing.

The term “generative artificial intelligence model” refers to a machine learning model configured to generate outputs such as text, images, or other data in response to input data or prompts, including, for example, large language models, image generation models, or multimodal generative models.

The term “prompt” refers to information supplied to a generative artificial intelligence model to control or guide its output, and may include instructions, questions, contextual data, and structured or unstructured text describing desired operations or outcomes.

The term “generate a prompt” refers to creating or assembling prompt content, including instructions and contextual information, in a form suitable for input to a generative artificial intelligence model so as to cause the model to produce a desired output.

The term “input the prompt” refers to supplying the generated prompt to a generative artificial intelligence model via an application programming interface (API), function call, or similar communication mechanism, thereby initiating processing by the model.

The term “combination of the clothing” refers to a set of two or more clothing items selected to be worn together as an outfit or coordination, such as a combination of a top, a bottom, outerwear, and shoes.

The term “user preference” refers to information indicating a user's tastes, likes, dislikes, or desired styles regarding clothing, which may be obtained from explicit settings, feedback, ratings, or inferred from user behavior and selection history.

The term “past selection history” refers to records of clothing combinations or individual clothing items previously selected or used by a user, including information such as dates of use, frequency of use, and contexts of use.

The term “optimal combinations of the clothing for a user” refers to combinations of clothing items that are evaluated as preferable for a particular user based on criteria such as user preferences, past selection history, seasonality, and usage context.

The term “usage frequency” refers to a measure of how often a particular clothing item has been used or selected over a given time period, which may be expressed as a count, rate, or similar metric.

The term “seasonality” refers to the suitability or association of a clothing item with one or more seasons or temperature ranges, such as spring, summer, autumn, or winter, based on attributes such as material, thickness, color, or design.

The term “unnecessary clothing items” refers to clothing items identified as not needed by a user, for example based on low usage frequency, long periods of non-use, seasonality, or explicit user settings indicating that such items are to be discarded or resold.

The term “organization of unnecessary clothing items” refers to processing that classifies, groups, or marks clothing items as unnecessary, and proposes or executes actions such as removal, storage, donation, or resale of such items.

The term “automatic listing on a market” refers to creating and registering sale listings of clothing items on an electronic marketplace or flea-market platform without requiring manual entry of listing details by the user, based at least in part on processing performed by the system and/or a generative artificial intelligence model.

The term “market” refers to an online or electronic marketplace, auction site, flea-market application, or similar platform where users can list, sell, or purchase goods including clothing items.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

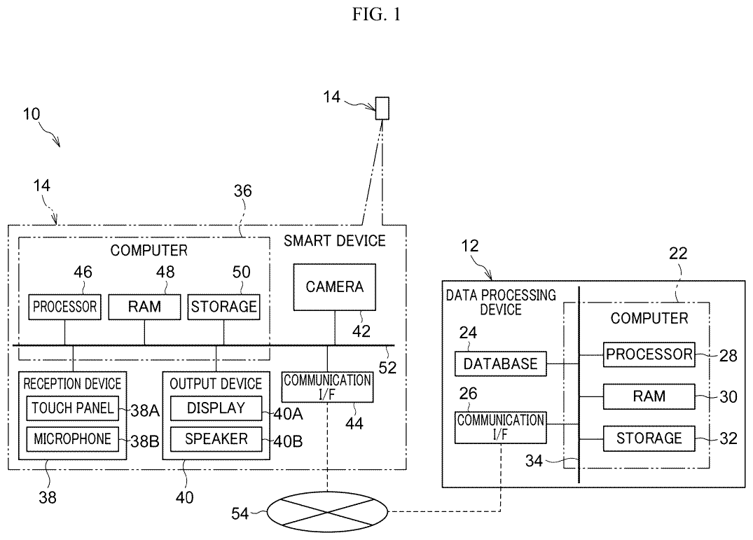

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

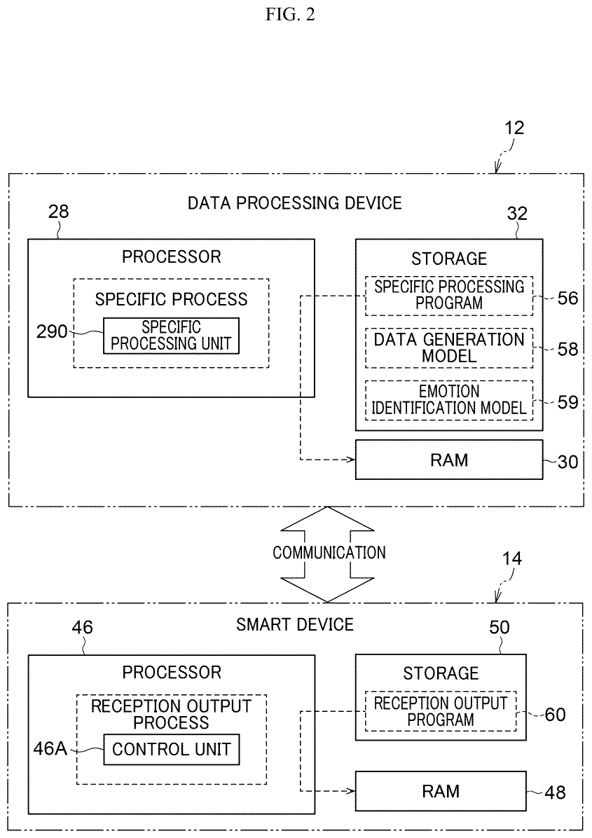

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented wardrobe management systems generally treat images of clothing items as static records, and rely on manually assigned tags or rigid rule-based logic to generate outfit suggestions. Such systems suffer from several technical limitations. First, heterogeneous data sources, such as clothing images, environmental information, and user schedule information, are not effectively integrated at the system level; image data are processed in isolation from contextual data, which leads to fragmented data representations in memory and storage. Second, traditional recommendation engines operate on pre-defined rules or simple attribute matching, resulting in inflexible computation paths that are difficult to adapt to changes in user behavior or environmental conditions, and that require frequent manual rule updates by developers. Third, user interaction data, such as selection or rejection of proposed outfits, are often stored only as application-level logs without being fed back into the core processing pipeline, so that the underlying computational processes do not improve over time in a systematic manner.

Moreover, when generative AI models are used in existing systems, such models are typically invoked in an ad hoc fashion with generic prompts that are not tightly coupled to the system's internal state. As a consequence, the generative AI outputs are not deterministically grounded in the clothing database, weather data, and schedule data maintained by the system, resulting in inconsistent or non-actionable proposals. The lack of a structured mechanism for generating context-aware prompt sentences and for binding generated natural language outputs back to structured clothing data causes inefficiencies in memory usage, repeated computations for similar requests, and difficulty in maintaining traceability between recommendations and source data.

In addition, conventional systems do not provide a robust computational mechanism to identify underused or seasonally inappropriate items as candidates for organization or disposal, nor do they integrate such determination with automated preparation of listing data for electronic transaction platforms. This results in redundant storage of obsolete items within the system's data structures, and prevents efficient utilization of storage and processing resources for active, high-relevance clothing items.

Thus, there is a need for an improved computer-implemented system that: (i) unifies image-based clothing data, contextual environmental data, and user schedule and feedback data into a coherent, structured representation; (ii) programmatically generates internal prompt sentences that precisely reflect the system's internal state and constraints for input to a generative AI model; (iii) systematically converts generative AI outputs into structured data that can be stored, indexed, and re-used; and (iv) uses accumulated history information to adapt and update at least part of the computational pipeline, thereby improving the technical performance of the wardrobe recommendation and management system over time.

The specific processing by the specific processing unit 290 of the data processing device 12 in Example 1 is realized by the following means.

The present invention provides a server comprising a processor, a storage device, and a communication interface, the processor being configured to control a portable client device to acquire and locally store image data of clothing items, to receive via the communication interface the image data and associated attribute data from the portable client device, to store the received image data in the storage device, to execute an information processing program including an image recognition program to extract feature information of each clothing item from the image data, to register the feature information as clothing management data in a structured format in the storage device, to obtain contextual data including weather information and schedule information from external information sources, to execute a computation process that generates candidate clothing combinations based on the clothing management data and the contextual data, to generate internal prompt sentences that explicitly describe the candidate clothing combinations and the contextual data, to input the internal prompt sentences into a generative AI model so as to cause the generative AI model to output natural-language clothing recommendation sentences, to convert the natural-language clothing recommendation sentences and associated clothing item identifiers into structured recommendation data, to transmit the structured recommendation data to the portable client device for display to a user, to receive user selection results from the portable client device, and to store the user selection results together with the contextual data as history information and to update at least part of the computation process and the internal prompt generation process using the history information. This enables the system to technically improve the integration of heterogeneous data sources, to generate AI prompts that are tightly coupled to the system's internal state, to bind generative outputs back into structured, machine-usable data, and to adapt the recommendation and item-management computation over time, thereby enhancing the efficiency, scalability, and accuracy of computer-based wardrobe management and recommendation processing.

The term “portable information terminal” refers to a mobile electronic device including at least a processor, a memory, a display, a communication interface, and an image capturing function, such as a smartphone, tablet, or similar handheld computing device operated by a user.

The term “image of an article of clothing” refers to digital image data representing a garment or wearable item owned or managed by a user, the image being captured by an imaging device and including visual information such as shape, color, pattern, and style of the garment.

The term “storage area of the portable information terminal” refers to a logical or physical memory region within the portable information terminal, such as internal flash memory or an application-specific data store, in which image data and related metadata are stored by execution of a program.

The term “computing apparatus” refers to an electronic data processing system, such as a server or server cluster, that includes at least one processor, memory, and a communication interface, and that is configured to receive, store, and process data transmitted from one or more portable information terminals.

The term “external storage device” refers to a non-volatile storage resource accessible by the computing apparatus via a storage interface or a network, such as a magnetic disk system, a solid-state storage system, or a network-based storage service, in which image data and processed data are retained.

The term “information processing program” refers to software instructions executable by the processor of the computing apparatus to perform data processing operations including image analysis, feature extraction, data integration, recommendation computation, and data management.

The term “image recognition program” refers to a component of the information processing program configured to analyze image data using algorithmic or machine-learning techniques, to identify visual features, and to output feature information such as object categories, colors, and patterns.

The term “generative artificial intelligence model” refers to a parameterized machine learning model, such as a neural network model, trained to generate output data including at least natural-language text in response to input data, and configured to receive prompt sentences and to output proposal sentences relating to clothing combinations or item management.

The term “feature information” refers to structured data representing characteristics of an article of clothing extracted from image data or related inputs, including at least a type, a color, a pattern, a style, or other attributes that can be used for classification, retrieval, and recommendation.

The term “clothing management data” refers to records stored in a structured format in the storage device, each record representing an article of clothing and including associated feature information, identifiers, and optional metadata used for wardrobe management and recommendation.

The term “external information providing apparatus” refers to a system or service accessible via a network that supplies contextual data, such as environmental, weather, or geographic information, in response to a request from the computing apparatus.

The term “weather information” refers to data describing environmental conditions for a given time and location, including at least temperature, precipitation, humidity, wind, or similar meteorological parameters relevant to selection of clothing.

The term “schedule management information processing apparatus” refers to a system or service that manages temporal event information for a user, such as a calendar server or scheduling application, and that can provide schedule information to the computing apparatus via a network.

The term “schedule information” refers to data describing one or more planned events of a user, including at least a date, a time, a location, and optionally an event type or activity description, which can influence the suitability of clothing combinations.

The term “candidate combinations of articles of clothing” refers to sets of two or more clothing items selected or computed by the computing apparatus as potential outfits, each set being generated based on clothing management data and contextual data.

The term “computation process” refers to a sequence of algorithmic operations executed by the processor, including mathematical calculations, filtering, scoring, and ranking, to generate candidate clothing combinations or to update model parameters and prompt generation logic.

The term “text data describing an internal state” refers to natural-language or structured textual content generated by the computing apparatus that encodes, in human-readable form, the current system context, including at least the candidate clothing combinations and relevant contextual data such as weather information and schedule information.

The term “prompt sentence” refers to text data supplied as an input to the generative artificial intelligence model, the text data describing at least one request or instruction together with context information, thereby conditioning the generative artificial intelligence model to output a corresponding response.

The term “clothing combination proposal sentence” refers to a natural-language text output by the generative artificial intelligence model in response to a prompt sentence, the text specifying one or more combinations of clothing items and optionally including reasons or explanations for such combinations.

The term “structured data” refers to data organized according to a predefined schema, such as records with fields or key-value pairs, wherein clothing combination proposal sentences are associated with identifiers or attributes of corresponding clothing items, enabling storage, retrieval, and further processing.

The term “user interface” refers to a visual or interactive presentation on the display device of the portable information terminal that shows images, text, and selectable elements, and that allows a user to view clothing recommendations and to perform selection operations.

The term “selection result” refers to information indicating a user's response to one or more clothing combination proposal sentences, including at least acceptance, rejection, modification, or preference input, which is transmitted from the portable information terminal to the computing apparatus.

The term “history information” refers to accumulated data stored in the storage device that records past interactions, including at least selection results, weather information, schedule information, and associated clothing combinations, used for learning and adaptation of the system.

The term “learning process” refers to a procedure executed by the processor to update parameters, weights, rules, or other elements of the computation process or prompt generation process, based on history information, so as to improve future recommendation performance.

The term “evaluation value” refers to a numerical or categorical metric calculated for a clothing item or combination, representing at least a degree of user preference or suitability, and used to bias or optimize subsequent recommendation computations.

The term “clothing attribute data” refers to clothing management data that has been augmented with one or more evaluation values or other derived metrics, and that is used to generate personalized recommendations.

The term “usage frequency” refers to a measure indicating how often a particular article of clothing has been selected or used over a given period, as derived from history information stored by the system.

The term “elapsed time” refers to a duration calculated from a reference moment, such as a purchase date, registration date, or last use date of an article of clothing, to a current time, and used as a factor in determining item relevance.

The term “seasonal suitability” refers to a measure indicating the appropriateness of an article of clothing for a particular season or environmental condition, derived from correlations between usage history and weather information.

The term “unnecessary-item candidate” refers to an article of clothing for which indices such as usage frequency, elapsed time, and seasonal suitability satisfy a predetermined condition indicating low relevance or need, and which is eligible for organization, disposal, or listing for transaction.

The term “attribute data and state data relating to the unnecessary-item candidates” refers to information including at least feature information, usage history, condition, and other descriptive properties of unnecessary-item candidates, used to generate prompts and listing information.

The term “transaction market” refers to an electronic commerce environment, such as an online marketplace or auction system, in which articles of clothing can be listed, discovered, and exchanged between parties.

The term “listing data” refers to structured information required to publish an item in a transaction market, including at least a title, a description, one or more images, a category, a price, and optional shipping or condition information.

The term “transaction server” refers to a server system that operates or provides access to a transaction market, receives listing data, and manages publication, search, and transaction processing for listed items.

In one embodiment, the system includes a server, one or more terminals, and one or more external information providing apparatuses interconnected via a communication network. The server includes at least one processor, a main memory, a non-volatile storage device, and a communication interface. The terminal includes at least one processor, a memory, a display device, a communication interface, and an image capturing device such as an integrated digital camera. The external information providing apparatus includes at least a processor, a memory, a storage device, and a communication interface, and operates as a weather information provider, a schedule management provider, or a transaction provider. The terminal uses a mobile operating system, such as a smartphone operating system, to execute an application program dedicated to wardrobe management. The terminal employs the image capturing device to acquire digital image data of clothing items. The terminal converts raw sensor data into encoded image data in a standardized format, such as JPEG or PNG, and stores the encoded image data in an application-specific storage area designated by the mobile operating system. The terminal associates each stored image with metadata including at least a local item identifier, a capture timestamp, and a user identifier, and records such metadata in a local structured data store, such as a relational table in an embedded database. This local data structuring enables the terminal to efficiently manage and retrieve images and associated records without scanning the entire file system, which reduces input/output overhead.

The terminal uses the communication interface to transmit the encoded image data and metadata to the server over a packet-based network using a secure transport protocol. The terminal constructs an application-layer message including at least the image data, the metadata, and an authentication token. The terminal transmits this message to the server's communication endpoint. The terminal then receives, from the server, structured response data indicating that the image has been registered in a centralized storage device and has been associated with a server-side item identifier.

The server uses a server-class operating system to execute an information processing program that includes multiple modules, such as a communication module, a data management module, an image recognition module, a recommendation computation module, a generative AI interface module, and a learning module. The server writes the received image data to the storage device, which may be implemented as a disk-based storage subsystem or a network-based storage service. The server stores each image at a storage location addressable by a uniform resource identifier. The server writes, into a structured database such as a relational database, a clothing management record including at least a server-side item identifier, a user identifier, the storage location of the image, and initial metadata.

The server uses the image recognition module to analyze the clothing image data. The image recognition module is implemented as a neural network model created using a machine learning framework such as a tensor processing framework or a dynamic computational graph framework. The server initializes a convolutional neural network architecture including multiple convolutional layers, non-linear activation layers, pooling layers, and fully connected layers, optionally combined with attention mechanisms. The server converts the clothing image data from the storage device into a numerical tensor format, normalizes pixel values, and resizes the images to a fixed spatial resolution. The server inputs the normalized image tensors into the convolutional neural network and performs forward propagation to obtain feature maps and class scores.

The server uses the output of the convolutional neural network to generate feature information for each clothing item. The server maps class scores to semantic categories such as a type (for example, top, bottom, outerwear, footwear), a color (for example, blue, black, white), a pattern (for example, solid, stripe, check), and a style (for example, casual, formal, sports). The server computes a confidence value for each predicted attribute using a probability function such as a softmax function applied to the network output. The server writes the resulting feature information and confidence values into the clothing management record for the corresponding item in the database. This structured representation enables the server to perform indexed queries and combination computations using attribute fields, rather than performing repeated full-image inference for each request, thereby reducing computational load and response time.

The server obtains contextual data from external information providing apparatuses. The server queries a weather information provider via the communication interface and receives weather information including at least a forecasted temperature, precipitation probability, and other environmental attributes for a given date and geographic region associated with the user. The server queries a schedule management provider or accesses schedule data stored locally, and receives schedule information including upcoming events with fields such as a date, a time, a location, and an event type. The server stores this contextual data in structured database tables, linking each record to a user identifier and time range. The server may also cache frequently accessed contextual data in a high-speed memory structure to reduce redundant network access and improve latency.

The server uses the recommendation computation module to generate candidate combinations of clothing items. The server retrieves, from the clothing management data, a set of items filtered according to weather information and schedule information. For example, the server excludes heavy outerwear when the forecasted temperature exceeds a threshold and excludes sandals when precipitation probability exceeds a threshold. The server further applies constraints derived from schedule information, such as requiring a minimum formality score for business events or allowing more casual items for leisure activities. The server calculates a score for each clothing item by combining multiple features, such as a formality score, a warmth score, a water resistance score, and an estimated user preference score. The server then constructs candidate combinations by grouping items into roles such as top, bottom, outerwear, and shoes, and computes a combination score by aggregating the individual item scores and color compatibility metrics. The server may use heuristic search, combinatorial optimization, or rule-based pruning to limit the combination search space and to reduce processing time, which improves computational efficiency compared to exhaustive enumeration.

The server uses the generative AI interface module to create internal prompt sentences that encode the system's current internal state. The server constructs a text string that includes a listing of selected clothing items with their feature information, a description of the weather information, and a description of the schedule information, as well as instructions for the generative AI model. For example, the server generates an internal prompt sentence such as: “User closet items: [1: ‘blue striped casual shirt’, 2: ‘black denim jeans’, 3: ‘denim jacket’, 4: ‘white sneakers’]. Today's weather: sunny, high 25° C., low 18° C. Schedule: afternoon casual meeting at a café. Based on the above, propose 3 specific outfit recommendations using only the listed items. Describe each outfit in one to two sentences and explain briefly why it is suitable.”

The server inputs this prompt sentence into a generative AI model. In one embodiment, the generative AI model is a transformer-based neural network including an embedding layer, multiple self-attention layers, feed-forward layers, and a language modeling head that outputs tokens representing natural-language text. The server tokenizes the prompt sentence into a sequence of tokens, converts the tokens into embedding vectors, and processes the embeddings through the transformer layers. The server sets generation parameters such as a maximum number of output tokens, a temperature parameter, and a probability cutoff parameter, and executes autoregressive token generation until a stopping condition is met.

The server obtains natural-language output text that includes clothing combination proposal sentences grounded in the items and contextual information specified in the prompt.

The server parses the generated text to extract distinct recommendation entries and associates each recommended clothing combination with corresponding item identifiers in the clothing management data. The server forms structured recommendation data that contains, for each recommendation, a list of clothing item identifiers, one or more natural-language clothing combination proposal sentences, and the associated combination score. The server stores this structured recommendation data in the storage device for future retrieval and analysis, thereby reducing the need to invoke the generative AI model again for identical or similar contexts.

The terminal receives the structured recommendation data from the server via the communication interface. The terminal queries the server or a content delivery mechanism for image thumbnails corresponding to the item identifiers included in each recommendation. The terminal renders a user interface that presents, on the display device, the images of the clothing items arranged according to each recommended combination and displays the clothing combination proposal sentences. The terminal provides selectable user interface components that allow the user to indicate acceptance, rejection, or modification of each recommendation.

The user uses the terminal to select one of the recommended combinations, to reject a combination, or to request alternative combinations. The user's selection operation generates a selection result including at least a selected combination identifier, a user identifier, and a timestamp. The terminal transmits this selection result to the server via the communication interface.

The server uses the learning module to update internal parameters based on history information including the selection results, weather information, and schedule information associated with each recommendation. The server computes, for each clothing item and each combination, an evaluation value that represents a preference degree. The server may model this evaluation value using techniques such as logistic regression, matrix factorization, or neural collaborative filtering, applied on top of the structured history information. The server writes the evaluation values into the clothing attribute data associated with the clothing management data. The server uses these updated evaluation values in future recommendation computations to bias selection toward items and combinations that have historically been accepted, thereby improving recommendation accuracy and reducing the number of unacceptable recommendations presented to the user.

The server further adjusts parameters of the computation process, such as weights assigned to weather, schedule, or aesthetic compatibility, based on aggregated history information. The server may apply gradient-based optimization using an objective function that measures discrepancy between predicted preference scores and actual user selections. The server may also refine the prompt generation rules, for example, by adding more explicit constraints to the prompt sentence when the generative AI model tends to propose items that are underused or oversuggested. This closed feedback loop improves the efficiency of the computational pipeline and reduces redundant or low-quality generative outputs.

The server can also use the clothing management data and history information to identify unnecessary-item candidates. The server calculates indices representing a usage frequency, an elapsed time since last use, and a seasonal suitability for each clothing item. The server compares these indices against predetermined thresholds or adaptive criteria and selects items that satisfy conditions indicative of low relevance or low usage. The server generates a prompt sentence describing these unnecessary-item candidates, including their feature information and status, and provides instructions for the generative AI model to create text describing organization strategies or listing descriptions for a transaction market. For example, the server may generate a prompt sentence such as:

“Here are items that have not been worn in the last 12 months and are suitable for spring and summer: [Item A: ‘light blue cotton shirt, casual, size M, good condition’, Item B: ‘white sneakers, size 26 cm, slightly worn’]. Propose a concise listing description and recommended category for each item for an online marketplace, in natural language.”

The server inputs this prompt sentence into the generative AI model and obtains listing text and associated category suggestions. The server structures this output into listing data, which can be transmitted to a transaction server for automatic or semi-automatic listing of items. By converting internal indices and history-based determinations into structured listing data through a controlled generative process, the system reduces manual data entry and optimizes the use of storage and processing resources by encouraging the removal of unused items. The system improves computer technology in several ways. The server reduces repeated heavy image analysis by storing feature information as structured records and performing most subsequent computations on compact attribute vectors instead of raw images, which lowers computational cost and accelerates response time. The server designs and uses internal prompt sentences that directly encode the state of the clothing database, the weather information, and the schedule information, which ensures that the generative AI model operates on a constrained and context-rich input, effectively reducing irrelevant or infeasible outputs and lowering network and compute resource consumption. The server uses a specific data structure in which generative outputs are bound to item identifiers, contextual attributes, and evaluation values, enabling efficient storage, indexing, caching, and re-use of recommendations. The server employs a learning process that updates computation weights, evaluation parameters, and prompt generation rules based on structured history information, thereby improving recommendation accuracy and reducing unnecessary network requests and model invocations over time.

Furthermore, the system performs operations that are not a mere automation of human mental processes. The server executes high-dimensional numerical operations, such as convolution over multi-channel image tensors and attention-based sequence processing, which cannot be feasibly performed manually at scale. The server applies non-obvious, non-conventional combinations of machine learning techniques, structured data management, and network communication control to achieve specific technical effects, such as reducing end-to-end latency for outfit recommendations, minimizing redundant model inference, and optimizing memory utilization by de-duplicating structured recommendation data. The system also directly controls physical devices, such as the terminal's camera and display, by coordinating when images are captured, how they are compressed, and how they are transferred over the network, which produces concrete improvements in imaging throughput and network bandwidth usage.

In another embodiment, the server uses an alternative neural network architecture, such as a vision transformer for feature extraction from images, or a hybrid model combining convolutional layers and transformer layers. The server may employ different learning algorithms, such as stochastic gradient descent with momentum or adaptive optimization methods, and may apply data augmentation techniques, such as random cropping or color jittering, during training to improve robustness of the feature extraction model. The generative AI model may be fine-tuned for the clothing recommendation domain using supervised learning on domain-specific prompt-response pairs, with a loss function that penalizes hallucinated items not present in the clothing management data. In yet another embodiment, the server may implement model distillation or quantization to reduce the size and computational requirements of the deployed generative AI model, further reducing latency and hardware costs.

In a further embodiment, the terminal pre-caches frequently used recommendation data or image thumbnails to reduce communication latency and to enable partial offline operation. The terminal may also locally maintain a simplified scoring mechanism to suggest basic combinations when the network connection is unavailable, and then reconcile local history with the server when connectivity is restored. These variations maintain the core architectural principle that the server maintains structured clothing management data, contextual data, and history information, generates context-bound prompt sentences, interacts with a generative AI model in a controlled and state-aware manner, and converts all relevant inputs and outputs into machine-usable structured data to achieve technical improvements in wardrobe management and recommendation computing.

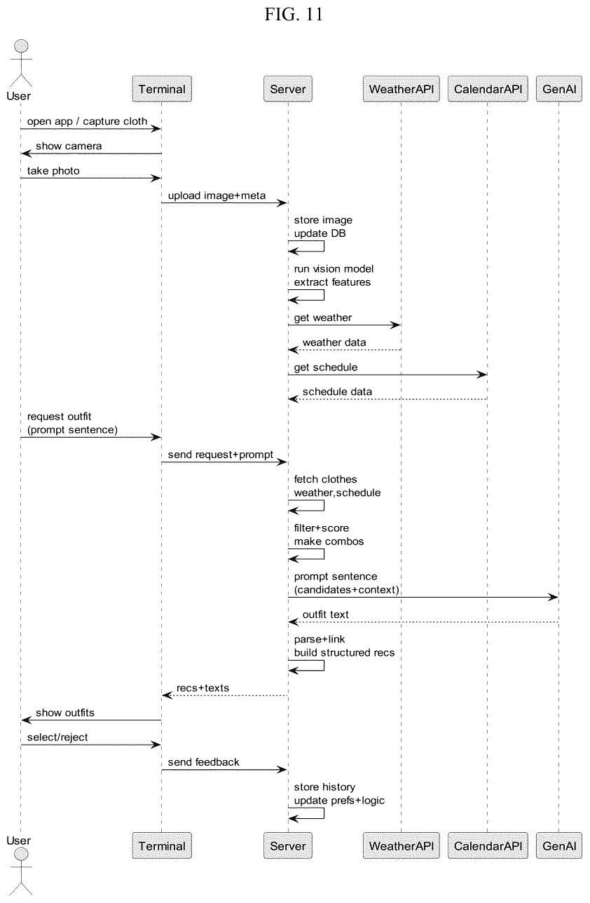

The following describes the processing flow using FIG. 11.

### Step 1:

The user uses the terminal to capture an image of a clothing item.

The user opens a wardrobe application on the terminal, points the terminal's camera at a clothing item, and taps a capture button.

The input is the real-world visual scene including the clothing item. The terminal converts this input into raw sensor data from the camera and encodes the raw sensor data into a digital image file in a format such as JPEG or PNG. The output is an encoded image file stored temporarily in memory of the terminal.

### Step 2:

The terminal stores the captured clothing image and local metadata.

The terminal writes the encoded image file into an application-specific storage area and generates metadata including a local item ID, a capture timestamp, and a user ID.

The input is the encoded image file and basic context information (time, user account). The terminal performs data processing by creating a local database record containing fields such as local_item_id, file_path, capture_time, and user_id, and by committing this record into a local structured data store. The output is a locally stored image and a corresponding metadata record available for later upload.

### Step 3:

The terminal prepares and transmits an upload request to the server.

The terminal reads the stored image file and its metadata from local storage, optionally compresses or resizes the image to reduce file size, and constructs a network request to send to the server.

The input is the image file path and metadata fields from the local database. The terminal performs data processing by encoding the image as binary data, packaging the binary data and metadata (user_id, device_id, capture_time) into an HTTP request body, and adding authentication information. The output is a transmitted HTTP request containing the clothing image and associated metadata sent over a communication network to the server.

### Step 4:

The server receives and validates the uploaded clothing image.

The server's communication module accepts the HTTP request, parses the headers, and extracts the binary image data and metadata. The server verifies an authentication token and checks constraints such as maximum file size and allowed image format.

The input is the HTTP request from the terminal containing the encoded image and metadata.

The server performs data processing by decoding the request body, verifying credentials against an authentication database, and checking file properties. The output is a validated image object and a metadata object that can be safely stored and processed.

### Step 5:

The server stores the clothing image and registers it as clothing management data.

The server writes the image data to a storage device and assigns a server-side item ID. The server then inserts a new record into a clothing table in a database, associating the server-side item ID with the user ID, image storage location, and any initial tags.

The input is the validated image data and metadata from Step 4. The server performs data processing by generating a unique identifier, constructing a database insert statement including fields such as item_id, user_id, image_url, upload_time, and raw_metadata, and executing this statement. The output is a persistent clothing management record that references the stored image and can be retrieved for analysis.

### Step 6:

The server loads the clothing image for feature extraction.

The server reads the stored image from the storage device using the image URL and converts the image into a numerical tensor format required by an image recognition model.

The input is the image URL and item_id from the clothing management record. The server performs data processing by loading the binary file, decoding it into pixel arrays, resizing it to a target resolution, and normalizing pixel values (for example, scaling to a [0,1] or [−1,1] range). The output is a normalized image tensor associated with the item_id.

### Step 7:

The server extracts feature information from the clothing image using an image recognition model.

The server inputs the image tensor into a convolutional neural network implemented with a machine learning framework such as a tensor processing framework or a dynamic graph framework.

The input is the normalized image tensor from Step 6. The server performs data computation by applying convolutional layers, activation functions, pooling layers, and fully connected layers to produce feature vectors and class logits. The server then applies a softmax function or similar normalization to obtain probability distributions over clothing types, colors, patterns, and styles. The output is structured feature information, such as {type: “top”, color: “blue”, pattern: “stripe”, style: “casual”, confidence_scores: . . . }, linked to the item id.

### Step 8:

The server stores the extracted clothing attributes in the clothing management data.

The server updates the existing clothing record with the feature information generated in Step 7.

The input is the feature information and the item_id. The server performs data processing by constructing an update operation on the database, setting fields such as type, color, pattern, style, and ai_confidence, and by writing these values into the corresponding row. The output is an enriched clothing management record that includes both image location and structured attributes for the clothing item.

### Step 9:

The server obtains and stores weather information associated with the user.

The server sends a request to a weather information provider, including the user's location and a target date, and receives weather forecast data.

The input is the user's geographic location and the target date, retrieved from a user profile table or from the terminal's request. The server performs data processing by transmitting a network request to the external provider, parsing the returned data (for example, temperature, precipitation probability, humidity), and inserting or updating a record in a weather_info table keyed by user_id and date. The output is structured weather information stored in the server's database for use in recommendation computations.

### Step 10:

The server obtains and stores schedule information associated with the user.

The server requests schedule data from a schedule management provider or reads schedule data from a local schedule table and processes upcoming events.

The input is a user identifier and a time range for which schedule information is needed. The server performs data processing by calling an external calendar API or querying a local schedule table, then normalizing the event data into fields such as event_id, start_time, end_time, location, and event_type. The output is a set of schedule records stored in a schedule_info table and linked to the user_id.

### Step 11:

The user requests an outfit recommendation using the terminal.

The user opens the application, selects an option such as “Recommend outfit,” and optionally enters a natural-language prompt sentence, for example, “Suggest today's outfit based on my closet and today's weather.”

The input is the user's explicit request and, optionally, a text prompt typed on the terminal.

The terminal performs data processing by packaging the user_id, current date, selected event (if any), and the prompt sentence into a request object. The output is an HTTP request sent from the terminal to the server, containing the recommendation request parameters and the prompt sentence.

### Step 12:

The server collects clothing, weather, and schedule data for recommendation.

The server receives the recommendation request and identifies the requesting user. The server then retrieves all active clothing items for the user, as well as corresponding weather and schedule information for the requested time.

The input is the user_id, date, and optional event information from the terminal's request.

The server performs data processing by querying the clothing management table for items associated with the user_id, querying the weather_info table for entries matching the date, and querying the schedule_info table for events overlapping the requested time. The output is a combined in-memory data set including clothing features, weather conditions, and schedule context.

### Step 13:

The server filters clothing items according to weather and schedule constraints.

The server applies rule-based and numeric filters to exclude clothing items that are unsuitable for the current context.

The input is the clothing feature set and the contextual data from Step 12. The server performs data computation by evaluating each item against formulas or thresholds, such as excluding “coat” items when predicted temperature is above a threshold or excluding “sandals” when precipitation probability exceeds a threshold, and by checking formality requirements based on event_type. The output is a reduced set of candidate items that satisfy minimum suitability constraints.

### Step 14:

The server scores clothing items and constructs candidate combinations.

The server calculates a numeric score for each remaining clothing item and groups items into possible outfits.

The input is the filtered item set from Step 13 and the contextual data. The server performs data computation by assigning or learning weights for features (for example, warmth, formality, water resistance, user preference score), computing a composite score for each item, and then creating combinations such as (top, bottom, outerwear, shoes). For each combination, the server computes an aggregate score that may include color compatibility metrics and diversity constraints. The output is a ranked list of candidate clothing combinations, each with an associated combination score and list of item IDs.

### Step 15:

The server constructs an internal prompt sentence for the generative AI model.

The server converts the candidate combinations and contextual data into a natural-language text description that will be used as a prompt sentence.

The input is the ranked list of candidate combinations, the weather information, the schedule information, and any user-provided prompt sentence. The server performs data processing by formatting selected clothing items as descriptive phrases (for example, “blue striped casual shirt,” “black denim jeans”) and assembling a text string that lists the items, describes the weather (for example, “sunny, high 25° C., low 18° C.”), and describes the schedule (for example, “afternoon casual meeting at a café”). The server embeds instructions such as “propose 3 specific outfit recommendations using only the listed items.” The output is one or more internal prompt sentences ready for input to the generative AI model.

### Step 16:

The server generates natural-language outfit suggestions using the generative AI model.

The server inputs the internal prompt sentence into a transformer-based generative AI model and obtains natural-language responses.

The input is the internal prompt sentence from Step 15. The server performs data computation by tokenizing the prompt into token IDs, encoding the tokens via embedding layers, processing them through self-attention and feed-forward layers, and generating output tokens step by step according to language modeling probabilities. The server configures generation parameters such as a maximum token length and a sampling strategy. The output is a block of text containing clothing combination proposal sentences, for example, “Wear the blue striped shirt with the black denim jeans and the denim jacket. This combination is casual yet neat, and the jacket will keep you comfortable in the cooler evening.”

### Step 17:

The server parses and structures the generative AI output.

The server analyzes the generated text to identify individual recommendation entries and link each entry to specific clothing item identifiers.

The input is the natural-language proposal text from Step 16 and the candidate combinations from Step 14. The server performs data processing by splitting the text into separate sentences or numbered items, matching descriptive phrases (for example, “blue striped shirt”) to clothing attributes in the clothing management data, and constructing structured records that map each proposal sentence to a set of item IDs and to a combination score. The output is structured recommendation data consisting of multiple recommendation entries with item IDs, proposal sentences, and scores.

### Step 18:

The server transmits the structured recommendation data to the terminal.

The server packages the recommendation entries into a response message for the terminal. The input is the structured recommendation data from Step 17. The server performs data processing by serializing each recommendation into a response format with fields such as outfit_id, item_ids, proposal_sentence, and ranking_position. The output is an HTTP response message sent to the terminal, containing all necessary data for the terminal to display the recommendations.

### Step 19:

The terminal displays recommended outfits and proposal sentences to the user.

The terminal receives the structured recommendation data, retrieves or requests image thumbnails for each clothing item, and renders the content on the display.

The input is the HTTP response from the server containing the recommendation entries. The terminal performs data processing by parsing the response, mapping item_ids to local or remote image URLs, and laying out images and text on the screen. The output is a graphical user interface showing each recommended outfit with the corresponding clothing images and natural-language proposal sentences, available for user selection.

### Step 20:

The user selects or rejects recommended outfits using the terminal.

The user scrolls through the displayed outfits, taps one outfit to expand details, and chooses an action such as “Select this outfit” or “Show another idea.”

The input is the visual presentation of recommendations on the terminal. The terminal converts the user's touch or click actions into selection results that include an outfit identifier, a chosen status (accepted or rejected), and a timestamp. The output is a structured selection result object stored temporarily on the terminal and prepared for transmission to the server.

### Step 21:

The terminal transmits the user's selection result to the server.

The terminal sends an HTTP request to the server indicating how the user responded to the recommended outfits.

The input is the selection result object from Step 20. The terminal performs data processing by inserting the user_id, outfit_id, action type, and timestamp into a request body and by attaching authentication tokens. The output is a feedback request transmitted over the communication network to the server.

### Step 22:

The server records history information including the selection result and context.

The server receives the feedback request and writes the selection result into a history table, linking it to the corresponding clothing items, weather conditions, and schedule context.

The input is the feedback request from the terminal and the contextual data previously used in the recommendation. The server performs data processing by fetching the relevant weather_info and schedule_info entries for the time at which the recommendation was generated, associating them with the outfit_id, and inserting a new record into a history table that includes user_id, outfit_id, decision (accepted or rejected), weather snapshot, and schedule snapshot. The output is an updated history database that accumulates user behavior over time.

### Step 23:

The server computes evaluation values for clothing items based on history information.

The server analyzes the history table to quantify user preferences and suitability metrics for items and combinations.

The input is the accumulated history records linked to clothing items and contexts. The server performs data computation by aggregating selection frequencies, computing acceptance ratios for each item and each combination, and optionally fitting a statistical or machine-learning model that predicts the probability of acceptance based on features. The server then writes evaluation values, such as user_preference_score, into the clothing attribute data for each item. The output is updated clothing management data with preference-weighted attributes, used to improve future recommendations.

### Step 24:

The server updates recommendation and prompt-generation logic using the learning module.

The server adapts internal weights and parameters used in the computation process and in the prompt sentence generation based on the newly computed evaluation values.

The input is the updated evaluation values from Step 23 and the existing weights or rules in the recommendation and prompt-generation modules. The server performs data computation by adjusting parameters such as feature weights (for example, increasing the weight of items with higher acceptance probability), updating threshold values for filtering, and modifying templates used to construct internal prompt sentences (for example, including more explicit constraints when items are overused). The output is an updated set of configuration parameters and rules that guide how future candidate combinations and prompt sentences are generated, thereby improving recommendation quality and computational efficiency.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional coordination support systems and wardrobe management systems largely treat image analysis, user preference handling, and product recommendation as separate and loosely-coupled processes. In many implementations, image data of wearable articles are merely tagged with coarse labels, and subsequent recommendation logic relies on static rules or manually-crafted templates without fully exploiting the expressive capabilities of generative AI models. As a result, the systems often generate generic, repetitive, or context-insensitive outfit suggestions that do not reflect the actual owned items of a user, the current availability of merchandise in a store, or the detailed constraints and preferences of the user.

Furthermore, known systems typically do not maintain a tightly integrated data flow from low-level image features, through structured wardrobe and merchandise representations, to dynamically constructed prompt sentences that drive a generative AI model. Image processing pipelines may extract some features, but they are not organized into user-specific owned-article information storage areas that can be efficiently queried and combined with external merchandise information storage devices. This causes inefficiencies in database access, difficulties in ensuring that recommended items are actually in stock, and limitations in generating timely, tailored coordination proposals in real-time in a physical store environment.

In addition, existing systems often treat generative AI models as black-box text generators, without systematically constructing prompt sentences that encode coordination generation conditions, constraint conditions, and user-specific preference and weighting information. This lack of prompt engineering at the system level leads to unstable output quality, inconsistent treatment of user preferences, and poor controllability of the resulting coordination proposals.

Moreover, known wardrobe systems do not consistently compute usage status indices such as number of wearings, unused periods, and seasonal attributes from stored image data and feature information. Without such indices, it is difficult to algorithmically identify unnecessary article candidates and to generate structured proposals for organization, disposal, or market listing. As a result, the systems cannot effectively support life-cycle management of wearable articles based on objective usage metrics.

Accordingly, there is a need for an improved computer-implemented system that integrates image acquisition, feature extraction, user-specific wardrobe management, merchandise database integration, and generative AI model interaction via structured prompt sentences. Such a system should manage feature information in a form suitable for efficient retrieval and association, construct controllable and context-rich prompt sentences that incorporate coordination generation conditions and user preferences, verify and structure the generative AI model outputs against underlying databases, and compute usage status indices to enable automated proposals for organizing and disposing of wearable articles. By addressing these issues, the invention aims to improve the technical functioning of the overall coordination support platform, including data processing efficiency, recommendation relevance, and robustness of generative AI-based outputs.

The specific processing by the specific processing unit 290 of the data processing device 12 in Application Example 1 is realized by the following means.

The present invention provides a server comprising a processor and a memory storing instructions which, when executed by the processor, cause the processor to acquire image data of wearable articles via an image input device and store the image data in a storage device within an information processing apparatus; execute an image processing program on the stored image data to extract feature information of the wearable articles including at least a category, a color, a pattern, and a style, and update a user-specific owned-article information storage area that manages the feature information on a per-user basis; obtain the feature information stored in the user-specific owned-article information storage area and attribute information of merchandise stored in an external merchandise information storage device, and convert both types of information into a data structure that enables association between the owned articles and the merchandise; generate a prompt sentence including coordination generation conditions and constraint conditions for combining wearable articles owned by a user and the merchandise, based on information acquired from the user-specific owned-article information storage area and the merchandise information storage device, and control input of the prompt sentence into a generative AI model; obtain a coordination proposal from the generative AI model, re-match the coordination proposal with the user-specific owned-article information storage area and the merchandise information storage device to verify validity of the coordination proposal, and format the coordination proposal as structured data based on a result of the verification; acquire images corresponding to the wearable articles and the merchandise included in the formatted coordination proposal and perform display control to present, on a display device, a coordination suggestion including the owned articles and the merchandise to the user; refer to a user preference information storage area and a selection history recording area that store user preferences, usage purposes, budget information, and past coordination selection histories, and add preference conditions and weighting information corresponding to the user to the prompt sentence so as to instruct the generative AI model to generate the coordination proposal in consideration of the preference conditions; and calculate usage status indices including at least a number of wearings, an unused period, and a seasonal attribute of each wearable article based on the stored image data and the feature information stored in the user-specific owned-article information storage area, extract unnecessary article candidates according to the usage status indices, and generate a prompt sentence for input to the generative AI model to cause the generative AI model to generate proposal content including at least an organization method, a disposal method, or listing content for a market with respect to the unnecessary article candidates. This enables an integrated and technically improved coordination support system in which low-level image features are converted into structured wardrobe and merchandise representations, dynamically constructed prompt sentences precisely control the behavior of the generative AI model, verification against underlying databases ensures that generated coordination proposals are consistent with actual inventory and user possessions, and computed usage status indices support automated life-cycle management of wearable articles, thereby enhancing data processing efficiency, recommendation quality, and robustness of generative AI-based outputs.

The term “processor” refers to a hardware logic unit or a set of hardware logic units, such as a central processing unit or a graphics processing unit, that executes instructions to perform arithmetic, logical, control, and input/output operations required by the system.

The term “memory” refers to a hardware storage resource, such as a volatile memory device or a non-volatile memory device, that stores instructions and data for access by the processor.

The term “information processing apparatus” refers to an electronic computing platform including at least a processor, a memory, and one or more interfaces that execute programs to process, store, and communicate data.

The term “image input device” refers to a hardware device, such as a camera or an image scanner, that captures visual information of physical objects and converts the visual information into digital image data.

The term “storage device” refers to a hardware component, such as a magnetic storage device, a solid-state storage device, or an optical storage device, that persistently stores digital data including image data and feature information.

The term “wearable article” refers to an item intended to be worn or carried on a human body, including garments, footwear, and accessories used for clothing or adornment.

The term “image data” refers to digital data representing a visual image, including pixel values and associated metadata, obtained from an image input device.

The term “image processing program” refers to a sequence of machine-executable instructions that, when executed by the processor, perform operations such as resizing, normalization, segmentation, and feature extraction on image data.

The term “feature information” refers to structured data describing attributes of a wearable article extracted from image data, including at least a category, a color, a pattern, and a style.

The term “category” refers to a type classification of a wearable article, such as top, bottom, outerwear, footwear, or accessory, used for organizing and coordinating wearable articles.

The term “color” refers to a chromatic attribute of a wearable article, represented as a label or as a numerical value, indicating one or more dominant colors detected from image data.

The term “pattern” refers to a visual repetition or design on the surface of a wearable article, such as solid, striped, checked, or printed, as determined from image data.

The term “style” refers to a qualitative attribute of a wearable article characterizing its usage context or fashion category, such as casual, formal, business, or street, derived from the appearance and shape of the article.

The term “user-specific owned-article information storage area” refers to a logical storage region in the memory or the storage device that stores and manages feature information of wearable articles on a per-user basis.

The term “merchandise information storage device” refers to a storage device that stores attribute information of articles offered for sale, including at least identification information, category, color, style, price, and availability.

The term “attribute information of merchandise” refers to structured data representing properties of a merchandise article, including at least a category, a color, a style, a price, and stock status.

The term “data structure that enables association” refers to an organization of data, such as a table, a record, a graph, or a key-value mapping, that allows the processor to relate feature information of user-owned wearable articles to attribute information of merchandise.

The term “coordination generation condition” refers to a rule or parameter used for selecting and combining wearable articles and merchandise, including constraints related to category compatibility, color harmony, style consistency, and usage context.

The term “constraint condition” refers to a limitation imposed on the generation of a coordination proposal, including constraints on budget, number of items, categories to be included, or availability in a particular sales location.

The term “prompt sentence” refers to a sequence of text, or a structured text representation, that encodes input instructions, conditions, and context information to be supplied to a generative AI model.

The term “generative AI model” refers to a trained machine learning model that generates output data, such as natural language text, in response to input data including prompt sentences and structured information.

The term “coordination proposal” refers to information specifying a combination of at least one user-owned wearable article and at least one merchandise article, including identification information and an optional explanation, output from the generative AI model or derived therefrom.

The term “structured data” refers to data organized in a machine-readable format, such as a record, a list, or a hierarchical representation, enabling efficient parsing, storage, and retrieval by the processor.

The term “display device” refers to a hardware output device, such as a monitor or a display panel, that visually presents images and text to a user.

The term “coordination suggestion” refers to a presentation on the display device showing at least images and identification information of selected wearable articles and merchandise, based on a coordination proposal.

The term “user preference information storage area” refers to a logical storage region that stores data representing a user's preferences, including at least preferred styles, preferred colors, target occasions, and budget ranges.

The term “selection history recording area” refers to a logical storage region that stores data indicating past selections or interactions of a user with coordination proposals, including accepted combinations, rejected combinations, and purchase records.

The term “preference condition” refers to a constraint or weighting factor derived from user preference information that influences the selection and ranking of wearable articles and merchandise in a coordination proposal.

The term “weighting information” refers to numerical or qualitative values that specify the relative importance of different preference conditions, coordination generation conditions, or constraint conditions when generating a coordination proposal.

The term “usage status index” refers to a numerical or categorical measure computed for each wearable article to indicate its usage state, including at least a number of wearings, an unused period, and a seasonal attribute.

The term “number of wearings” refers to a count or estimate of how many times a wearable article has been used, derived from user inputs, interaction logs, or inferred usage events.

The term “unused period” refers to a time interval during which a wearable article has not been used or worn, computed from timestamps associated with usage events or registrations.

The term “seasonal attribute” refers to an attribute indicating a season or temperature range suitable for a wearable article, such as warm season, cold season, or all-season, determined from its material, thickness, or design.

The term “unnecessary article candidate” refers to a wearable article identified, based on usage status indices and threshold conditions, as potentially suitable for removal, disposal, or transfer from a user's wardrobe.

The term “proposal content” refers to information generated by the generative AI model describing recommended actions for a wearable article, including an organization method, a disposal method, or listing content for offering the article in a market.

The term “organization method” refers to a suggested procedure for arranging or categorizing wearable articles, such as grouping by season, usage frequency, or style.

The term “disposal method” refers to a suggested manner of discarding or transferring a wearable article, such as donation, recycling, or waste disposal.

The term “listing content for a market” refers to textual or structured information suitable for registering a wearable article on a sales platform, including at least a title, a description, a category, and recommended price information.

In one embodiment, a server, a terminal, and a user cooperate to implement the claimed system. The server includes at least one processor, a main memory, a non-volatile storage device, and a network interface. The terminal includes a processor, a memory, a display device, a communication interface, and an image input device such as a camera. The user operates the terminal to capture images of wearable articles and to view coordination suggestions. The server executes software components that perform image analysis, data management, prompt sentence generation, interaction with a generative AI model, and output formatting for display on the terminal.

The server uses a general-purpose computing platform, such as a computing node with a central processing unit and optionally a graphics processing unit, running an operating system. The server executes an image processing program implemented in a programming language such as Python, using an image processing library such as an image manipulation library and a machine learning framework such as TensorFlow. The server also uses a database management system, which may be implemented as a relational database or a non-relational database, to store user-specific owned-article information and merchandise information. The server further uses a communication client module to communicate with an external generative AI model service over a network.

The terminal uses an operating system for mobile devices and executes an application program that provides a user interface for capturing images, transmitting data to the server, and displaying coordination suggestions. The terminal uses a camera driver and associated application programming interfaces to capture image data of wearable articles. The terminal uses a network stack to send and receive messages over a wireless network to and from the server.

The server stores, in the memory or the non-volatile storage device, a module configuration in which an image acquisition module, an image analysis module, a wardrobe management module, a merchandise integration module, a prompt generation module, a generative AI interaction module, a result verification and structuring module, a usage status calculation module, and a display preparation module are logically separated but can exchange data through defined data structures. The server configures an internal data bus or an inter-process communication mechanism to transfer data among these modules.

The server uses the image acquisition module to receive image data sent from the terminal.

The server receives the image data in a compressed format such as JPEG and stores the image data in a storage device. The server associates each image with a user identifier and a provisional article identifier and stores such associations in an image index table. The server uses the image processing program to decode the compressed image data into a numerical array of pixel values. The server uses a preprocessing pipeline that normalizes the pixel values, resizes the image to a fixed resolution required by the generative AI model, and optionally segments foreground wearable articles from the background using a segmentation network or a color-based segmentation algorithm.

The server uses the image analysis module to extract feature information from the preprocessed image data. The server loads a neural network model implemented using TensorFlow, which may be a convolutional neural network including multiple convolutional layers, pooling layers, and fully connected layers. The server configures this network to output logits or probability distributions over predetermined classes representing categories of wearable articles, patterns, and styles. The server can also compute color features by aggregating pixel histograms in a color space and mapping the histograms to discrete color labels.

The server trains the neural network model in advance using a supervised learning procedure.

The server uses a training dataset comprising many labeled images of wearable articles. The server defines a loss function such as a cross-entropy error between the predicted class probabilities and ground truth labels. The server updates the network weights using a gradient-based optimization algorithm such as stochastic gradient descent or Adam. The server may employ data augmentation techniques such as random cropping, rotation, color jittering, and horizontal flipping to improve the robustness and generalization ability of the model. The server stores the trained weights in the storage device and loads them into memory at runtime.

The server uses the image analysis module to perform inference by feeding the preprocessed image through the trained network. The server obtains intermediate feature vectors from one or more hidden layers and treats these feature vectors as embeddings representing high-level visual characteristics of the wearable article. The server uses these embeddings in combination with the predicted category, color, pattern, and style labels as the feature information of the wearable article. The server writes this feature information into a user-specific owned-article information storage area in the database.

The server defines the user-specific owned-article information storage area as a set of records keyed by user identifiers and article identifiers. Each record stores fields such as a category field, a color field, a pattern field, a style field, an image reference field, and one or more embedding fields. The server builds indexes over the category, color, and style fields and may store embeddings in a vector index to support similarity search. This structured representation improves data retrieval performance compared to simple unstructured tags.

The server integrates merchandise information from an external merchandise information storage device. The server periodically receives merchandise records from a merchandise provider via an application programming interface or direct database access. The server writes the merchandise records into a merchandise table in the database, where each record includes fields such as a merchandise identifier, a store identifier, a category, a color, a style, a price, and a stock status. The server may also compute embeddings for merchandise images using the same or a related neural network architecture to align the feature space of user-owned articles and merchandise.

The server uses the wardrobe management module and the merchandise integration module to create a data structure that enables association between user-owned wearable articles and merchandise. The server may represent this association structure as a bipartite graph or as a joinable table linking article identifiers and merchandise identifiers with compatibility scores.

The server calculates initial compatibility scores using rule-based conditions such as matching or complementary categories and color harmony rules, as well as similarity metrics computed from embeddings such as cosine similarity. The server stores these compatibility scores in a dedicated compatibility table.

The server uses the prompt generation module to construct a prompt sentence for a generative AI model. The server reads relevant records from the user-specific owned-article information storage area and the merchandise information storage device, and summarizes them into a textual description. The server also reads records from a user preference information storage area and a selection history recording area, which store user preferences such as preferred styles, colors, and budget, as well as accepted and rejected past coordination proposals.

The server converts this structured data into a prompt sentence that includes coordination generation conditions and constraint conditions. For example, the server can generate a prompt sentence in plain text form as follows:

The user's closet contains a blue casual shirt and black casual pants. The store currently offers the following jackets: (1) a red casual jacket priced at 8,000, (2) a grey formal blazer priced at 12,000, and (3) a green street-style bomber jacket priced at 9,000. Considering color harmony, style compatibility, and everyday usability, select the best jacket to coordinate with the blue shirt and black pants. Return the selected product identifier and a brief coordination description.

The server may generate a different prompt sentence that includes preference information: The user prefers casual style and a budget under 10,000. The user owns a blue casual shirt and black casual pants. The store offers several jackets in red, grey, and green with different styles and prices. Considering the user's preferences and budget, recommend one jacket that best matches the outfit and explain the reason briefly.

The server generates such prompt sentences systematically based on templates and parameter insertion, rather than as arbitrary human-written text. The server applies a predefined grammar and formatting rules to arrange the data, ensuring that the generative AI model receives consistent and machine-generated instructions. This structured prompt generation improves the stability of the generative AI model outputs and reduces ambiguity.

The server uses the generative AI interaction module to send the prompt sentence to a generative AI model. The server may host the generative AI model locally using a transformer-based neural network architecture or may access a remote generative AI model service. In a local implementation, the server loads a language model composed of multiple attention layers, feed-forward layers, and layer normalization components. The server uses tokenization to convert the prompt sentence into token identifiers and uses positional encoding for sequence processing. The server performs inference by feeding the token sequence into the model and generating token sequences representing the model's completion. The server may set decoding parameters such as temperature and maximum output length to control diversity and length.

In training of the generative AI model, the server or an external provider uses a corpus of text data including descriptions of outfits, user preferences, and merchandise attributes. The training process uses a loss function such as cross-entropy between predicted tokens and ground-truth tokens and updates model parameters by backpropagation. The server may further fine-tune the model on domain-specific text data including fashion coordination examples and prompt-response pairs. This fine-tuning improves the relevance of generated coordination proposals.

The server receives the output text from the generative AI model and parses it to extract a coordination proposal. The server uses the result verification and structuring module to validate the coordination proposal against the underlying databases. The server checks whether the merchandise identifiers specified in the proposal actually exist and are in stock.

The server checks whether the user-owned articles referenced in the proposal are present in the user-specific owned-article information storage area. The server also checks whether the proposal satisfies constraint conditions such as budget limits or required categories.

The server reformats the verified proposal as structured data. The server constructs a record comprising references to user-owned article identifiers, merchandise identifiers, and descriptive text. The server may assign scores or rankings to each proposal based on how well it satisfies compatibility rules and user preferences. The server stores these records in a coordination proposal table for logging and further analysis.

The server uses the usage status calculation module to compute usage status indices for each wearable article. The server updates a usage record whenever the user selects or confirms a coordination proposal, indicating that certain articles were used. The server calculates a number of wearings by incrementing counts, calculates an unused period by subtracting the last usage date from the current date, and assigns a seasonal attribute based on the article's material, thickness, and historical usage patterns in different calendar months. The server may use a classification network or rule-based logic to map features to seasonal attributes.

The server identifies unnecessary article candidates by comparing usage status indices against threshold values. For example, the server can mark an article as a candidate if it has not been used for more than a predetermined period or if its usage count remains below a predetermined threshold over a season. The server then generates a prompt sentence for the generative AI model that asks for recommendation of organization or disposal strategies. The server may use a prompt sentence such as:

The user owns a long coat that has not been worn for 18 months and is suitable for cold seasons. Considering that the coat is rarely used, propose whether the user should keep, donate, recycle, or sell the coat, and provide suggested listing text if selling is recommended.

The server receives a response from the generative AI model that may include suggested actions and draft listing content. The server parses and structures this content and makes it available for display on the terminal.

The terminal receives coordination proposals and organization proposals from the server. The terminal requests image data corresponding to the user-owned articles and merchandise from the server or from an image storage service. The terminal composes a visual layout where images and text descriptions are combined. The terminal renders the layout on the display device and allows the user to scroll or switch between different proposals.

The server's architecture and algorithms improve computer technology rather than merely automating a human mental process. The server uses a specific combination of data structures, neural network architectures, and algorithmic flows to reduce processing time and improve accuracy. For instance, by extracting embeddings for wearable articles and merchandise and storing them in vector indexes, the server can precompute compatibility scores and quickly retrieve candidate combinations without scanning entire tables. This reduces database query load and computational overhead. By structurally generating prompt sentences that encode coordination generation conditions and preferences, the server constrains the input space to the generative AI model, reducing the risk of irrelevant or inconsistent outputs and thereby lowering post-processing time.

The server's verification step, which re-matches generative AI outputs against the user-specific owned-article information storage area and the merchandise information storage device, prevents invalid or unavailable items from being presented to the user. This additional layer of consistency checking is not present in simple human-driven coordination and directly improves system reliability. The server's calculation of usage status indices and threshold-based selection of unnecessary article candidates provide an algorithmic basis for wardrobe life-cycle management that is not achievable by unaided human memory at large scale.

The server's use of neural network models with defined architectures, loss functions, weight updates, and data augmentation provides technical details of feature extraction and text generation that go beyond abstract concepts. The server's modules exchange data via explicit data structures, and the processing flow is determined by algorithmic rules for filtering, similarity computation, constraint satisfaction, and prompt formatting. These features collectively improve data management and computational efficiency.

In another embodiment, the server may host the generative AI model entirely within the local infrastructure, using a transformer network with a reduced parameter count optimized for low-latency inference. The server may implement quantization or pruning techniques to decrease model size and improve inference speed. The server may also implement caching mechanisms that store previously generated coordination proposals for similar user profiles and closet states, thereby avoiding redundant computation. In another variant, the server may use different neural architectures for feature extraction, such as residual networks or vision transformers, and combine their outputs to improve robustness.

In a further embodiment, the terminal may perform partial feature extraction on-device to reduce communication load. The terminal may run a lightweight convolutional network to compute intermediate feature maps and send compressed feature vectors instead of raw images to the server. The server then performs final classification and embedding generation. This split-processing architecture reduces bandwidth usage while maintaining central control of model updates on the server side.

The system thus provides a detailed mechanism by which the server and the terminal cooperate to implement wardrobe management and coordination support. The server performs non-conventional processing by combining structured feature extraction, database-backed association, and prompt-engineered interaction with a generative AI model, and by enforcing consistency and technical constraints on the outputs. This integrated design produces technical effects such as reduced latency in generating proposals, improved accuracy of item matching, better utilization of storage and computation resources, and enhanced robustness of generative AI outputs in real-world usage.

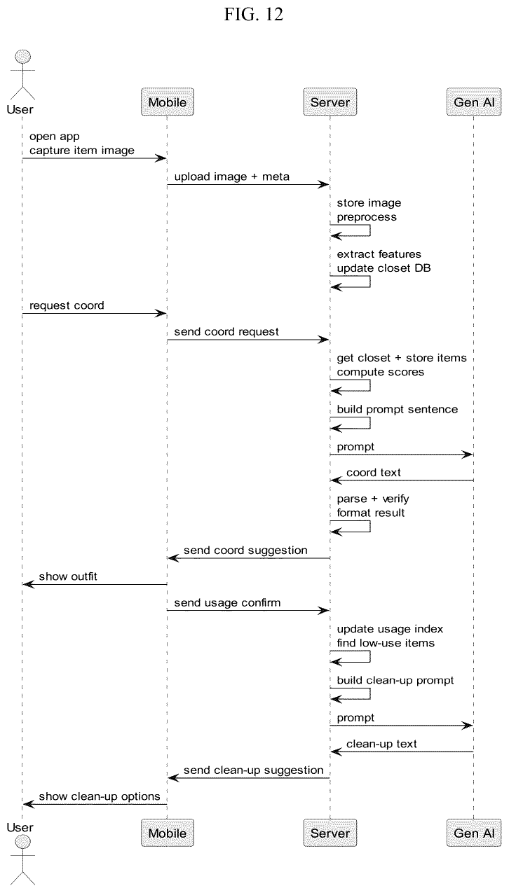

The following describes the processing flow using FIG. 12.

### Step 1:

User operates the terminal to capture wearable article images.

User launches an application on the terminal and selects a function for registering closet items. User holds the wearable article in front of the camera and captures one or more images. The input is a physical wearable article and camera sensor data, and the output is digital image data in a format such as JPEG stored temporarily in the terminal's memory.

### Step 2:

Terminal preprocesses the captured images and prepares upload data.

Terminal receives the raw image data from the camera driver and resizes the image to a predetermined resolution, compresses it to a target quality, and attaches metadata such as user identifier, tentative category, and timestamp. The input is raw image data and user metadata, and the output is a preprocessed image file and a metadata record packaged into a message body suitable for network transmission.

### Step 3:

Terminal transmits image data to the server over a network.

Terminal opens a network connection using a secure protocol and embeds the image file and metadata into an HTTP request. Terminal adds an authentication token to the header and sends the request to a specified server endpoint. The input is the preprocessed image package and authentication information, and the output is a network packet stream that carries the image data to the server and a pending request state maintained by the terminal.

### Step 4:

Server receives and stores the raw image data.

Server accepts the incoming HTTP request through a web application interface, validates the authentication token, and verifies the file type and size of the image. Server generates a unique identifier for the image and writes the file into a storage device while inserting an index entry into an image table linking the image with the user. The input is the network packet stream containing the image and metadata, and the output is a stored image object and a corresponding database entry with a status field set to pending analysis.

### Step 5:

Server decodes and normalizes image data for feature extraction.

Server reads the stored image file from the storage device using the file path recorded in the database and decodes the compressed image into an array of pixel values. Server applies preprocessing operations such as resizing to a fixed dimension, color space conversion, normalization of pixel intensity, and, when configured, background segmentation using a segmentation algorithm. The input is the stored compressed image file, and the output is a normalized image tensor suitable as input to a neural network model.

### Step 6:

Server performs feature extraction using a vision neural network.

Server loads a trained convolutional neural network into memory using a machine learning framework and feeds the normalized image tensor into the network's inference function.

Server computes activations through convolutional layers and pooling layers and obtains class probabilities and intermediate feature vectors. Server maps the output probabilities to discrete labels representing category, color, pattern, and style, and stores the intermediate feature vector as an embedding. The input is the normalized image tensor, and the output is structured feature information including labels and an embedding vector for the wearable article.

### Step 7:

Server updates the user-specific owned-article information storage area.

Server creates or updates a record in a user-specific table using the user identifier and generates a new article identifier. Server writes the category, color, pattern, style, embedding vector, image reference, and timestamps into the record and updates data indexes. The input is the structured feature information and user identifier, and the output is a persistent database record that associates the wearable article with the user and makes it searchable for later coordination processing.

### Step 8:

Server maintains and refreshes merchandise information.

Server periodically receives merchandise data from an external merchandise information source, parses the incoming records, and writes them into a merchandise table. Server normalizes attributes such as category, color, style, price, and stock status and may compute merchandise embeddings by passing merchandise images through the same or a similar vision neural network. The input is raw merchandise data and optional merchandise images, and the output is a set of normalized merchandise records and embeddings stored in a structured database schema.

### Step 9:

User requests coordination suggestions in a store context.

User visits a retail location and opens the terminal application to request outfit recommendations. User optionally enters constraints such as target occasion or budget and confirms that the system should use the current location or a store identifier to limit merchandise candidates. The input is the user's interaction with the user interface and store context, and the output is a coordination request specification held by the terminal including user identifier, store identifier, and preference parameters.

### Step 10:

Terminal sends a coordination request to the server.

Terminal collects the user identifier, store identifier, and the constraint parameters from the application state and formulates a structured request message. Terminal attaches authentication information and sends the request to the server's coordination endpoint. The input is the coordination request specification, and the output is a network message that signals the server to start coordination generation for the specified user and store.

### Step 11:

Server retrieves candidate user-owned articles and merchandise items.

Server reads the coordination request, validates the identifiers, and queries the user-specific owned-article information storage area to obtain candidate items such as tops, bottoms, and frequently used garments. Server also queries the merchandise table for items associated with the specified store identifier that are in stock and compatible with general constraints such as category and price bounds. The input is the coordination request and the database contents, and the output is a set of candidate user-owned article records and a set of candidate merchandise records ready for further processing.

### Step 12:

Server computes compatibility scores between owned articles and merchandise.

Server processes the candidate sets by applying compatibility rules and similarity computations. Server calculates color harmony scores based on predefined color pair rules, style consistency scores based on style labels, and similarity scores using cosine similarity between article embeddings and merchandise embeddings. Server aggregates these values into compatibility scores for each potential pair or combination and stores the results in a temporary compatibility structure. The input is the feature information and embeddings of the candidate items, and the output is a set of compatibility scores that indicate numerically how well each combination fits the defined criteria.

### Step 13:

Server constructs a structured prompt sentence for the generative AI model.

Server selects top-ranked combinations based on the compatibility scores and extracts their attributes and identifiers. Server reads user preference information and selection history to derive additional conditions such as preferred colors and style weighting factors. Server formats these attributes and conditions into a prompt sentence following a predetermined template, inserting text descriptions of the user's closet items, available merchandise, and explicit instructions for how the generative AI model should choose and explain a coordination. The input is the candidate combinations, user preferences, and compatibility scores, and the output is a single prompt sentence or a set of prompt sentences that provide a textual specification of the coordination generation task.

### Step 14:

Server sends the prompt sentence to the generative AI model and obtains a textual response.

Server tokenizes the prompt sentence and passes the token sequence to a transformer-based language model hosted locally or remotely. Server configures inference parameters such as maximum token length and temperature and runs the forward pass of the network to generate an output token sequence. Server decodes the token sequence back into natural language text describing the recommended coordination and, when applicable, including selected merchandise identifiers and justification. The input is the constructed prompt sentence, and the output is a textual response from the generative AI model that embodies a raw coordination proposal.

### Step 15:

Server parses and verifies the coordination proposal against stored data.

Server analyzes the textual response by extracting identifiers and article descriptions using pattern recognition or parsing rules. Server checks the existence and stock status of the referenced merchandise identifiers in the merchandise table and checks the presence of referenced user-owned articles in the user-specific storage area. Server confirms that the total price and category composition satisfy the constraints specified in the coordination request. The input is the textual response from the generative AI model and the underlying database records, and the output is a validated coordination proposal structure that either passes all checks or is flagged for adjustment or rejection.

### Step 16:

Server formats the validated proposal as structured data for presentation.

Server converts the verified coordination structure into a representation that includes ordered lists of user-owned item identifiers and merchandise identifiers, along with human-readable descriptions and optional scores. Server attaches references to image locations for each item and stores the result in a transient response object. The input is the validated coordination proposal, and the output is a structured coordination response ready to be transmitted to the terminal.

### Step 17:

Server calculates usage status indices based on accepted proposals.

Server updates usage records of wearable articles by incrementing usage counters for any owned items that appear in accepted or confirmed coordination proposals reported by the terminal. Server recalculates an unused period by comparing the current date with the last recorded usage date and updates the seasonal attribute if patterns in usage over time change. The input is the history of confirmed coordination selections and timestamps, and the output is an updated set of usage status indices stored in association with each wearable article in the user-specific storage area.

### Step 18:

Server derives unnecessary article candidates from usage indices.

Server evaluates each wearable article's usage status indices against predefined thresholds, such as a maximum unused period or a minimum usage count. Server marks items that exceed thresholds as unnecessary article candidates and records this status in the database. The input is the set of updated usage status indices and threshold parameters, and the output is a list of unnecessary article candidates flagged for potential organization, disposal, or market listing.

### Step 19:

Server generates a prompt sentence for organization or disposal proposals.

Server gathers details of each unnecessary article candidate, including category, color, style, seasonal attribute, and usage history, and formats these into a descriptive context. Server constructs a prompt sentence instructing the generative AI model to propose an organization method, a disposal method, or a listing description for a market. The input is the attributes of unnecessary article candidates and the usage status indices, and the output is one or more prompt sentences that request specific lifecycle management suggestions for those items.

### Step 20:

Server obtains and structures organization or disposal suggestions.

Server submits the lifecycle management prompt sentence to the generative AI model, receives a textual response describing recommended actions and, when applicable, suggested listing text. Server parses the response to separate action categories and textual descriptions and stores the suggestions as structured records associated with each unnecessary article candidate. The input is the lifecycle management prompt sentence, and the output is a set of structured suggestions for organizing, disposing of, or listing wearable articles.

### Step 21:

Server sends coordination and lifecycle proposals to the terminal.

Server packages both coordination proposals and lifecycle management suggestions into a response message, including references to item images and explanatory text. Server sends this message through the network interface to the terminal. The input is the structured coordination response and the structured lifecycle suggestions, and the output is a network response that conveys these data to the terminal for presentation.

### Step 22:

Terminal renders proposals on the display for user interaction.

Terminal receives the response message, parses the structured data, and retrieves or requests associated images from the server or a storage service. Terminal arranges the owned items and merchandise items into a graphical layout, shows recommended combinations and explanations, and displays organization or disposal suggestions with optional listing drafts. The input is the server response and associated images, and the output is a set of rendered screens on the display device that the user can view and interact with.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented wardrobe management systems largely rely on static rule sets and manual user input for identifying missing clothing items and for generating purchase recommendations. In such systems, a processor typically stores item data and may suggest combinations, but the processor is not technically integrated with a generative AI model and external commerce platforms in a way that allows end-to-end, data-driven automation. As a result, several technical problems arise.

First, existing systems require the user to repeatedly search external commerce services, interpret unstructured recommendation outputs, and manually translate those outputs into concrete search conditions. This imposes significant processing on the user and leads to inefficient utilization of computing resources, because the processor does not automatically convert the high-level semantic output of a generative AI model into structured search queries for remote information processing apparatuses. The gap between natural-language recommendations and machine-readable search parameters causes redundant user interactions, repeated network calls, and fragmented data processing.

Second, in conventional architectures, the processor does not maintain a feedback loop between purchase results, user preferences, and subsequent recommendation generation. Preference and budget information is often stored as static settings, and recommendation logic does not automatically adapt based on actual purchase history and user behavior. This lack of adaptive updating leads to suboptimal matching between proposed items and user constraints, and forces repetitive reconfiguration by the user. From a computer technology perspective, this means that the processor executes independent, non-coordinated modules instead of an integrated pipeline, resulting in increased processing overhead and duplicated data analysis.

Third, prior systems that attempt to use AI models for recommendation typically treat the AI output as an endpoint, presenting the output directly to the user without linking it to remote commerce platforms at the system level. The processor does not automatically parse description information produced by the generative AI model, derive structured search conditions, and use those conditions to acquire concrete product information from external sales information processing apparatuses over a communication network. Consequently, the system cannot efficiently bridge semantic recommendation data and structured commerce data, which leads to additional network transactions, inconsistent search behavior, and poor reuse of intermediate computational results.

Fourth, automatic purchasing, when available, is often implemented as a simple rule-based trigger separate from the recommendation logic, without unified control over shortage identification, AI-based proposal generation, product comparison, and order execution. This fragmented design causes technical inefficiencies: the processor must handle multiple independent workflows, maintain separate data formats, and perform repeated data conversions and validations, which increases processing time and memory usage. Accordingly, there is a need for an improved computer-implemented system and processor control method that (i) automatically identifies shortage elements in a user's garments based on stored garment information, (ii) generates and inputs prompt sentences to a generative AI model to obtain candidate clothing articles, (iii) automatically parses the generative AI output to extract search conditions, (iv) acquires and compares product information from remote sales information processing apparatuses using those search conditions, (v) executes automatic purchase processing when appropriate, and (vi) updates user preferences and budget information based on garment information and purchase results to dynamically modify subsequent prompt sentences. Such a system improves the overall efficiency, integration, and adaptability of the underlying computer technology by forming a closed-loop, data-driven control pipeline across local storage, AI inference, network communication, and transaction execution.

The specific processing by the specific processing unit 290 of the data processing device 12 in Example 2 is realized by the following means.

The present invention provides a server comprising a processor and a storage unit, the processor being configured to acquire information relating to garments and store the information in the storage unit, analyze attribute information of the garments based on the information stored in the storage unit and identify shortage elements of the garments, generate a prompt sentence for causing a generative AI model to propose candidate clothing articles that complement the shortage elements based on the shortage elements, preference information of a user, and budget information of the user, input the prompt sentence to the generative AI model, acquire product information from at least one sales information processing apparatus over an information communication network based on product attributes corresponding to the candidate clothing articles output from the generative AI model, compare and evaluate the product information to select at least one recommended product, execute, in accordance with purchase conditions of the user and an automatic purchase setting, a purchase process for the at least one recommended product with respect to the at least one sales information processing apparatus automatically, notify the user of purchase result information, update the preference information and the budget information of the user based on the information relating to garments stored in the storage unit and the purchase result information, dynamically modify the prompt sentence based on the updated preference information and budget information, analyze description information of the candidate clothing articles output from the generative AI model, extract search conditions from the description information, and use the search conditions for acquiring the product information so as to link an output result of the generative AI model with the product information acquired from the at least one sales information processing apparatus over the information communication network. This enables an integrated and adaptive control pipeline in which the server automatically transforms stored garment information into shortage detection results, converts user-specific context into optimized prompt sentences for the generative AI model, translates natural-language AI output into structured search conditions, efficiently acquires and ranks product information from remote commerce platforms, executes automatic purchase processing under system-controlled constraints, and continuously refines subsequent AI prompts and selection criteria based on actual purchase outcomes, thereby improving computational efficiency, reducing redundant user interactions, and enhancing the technical performance of the wardrobe management and recommendation system as a whole.

The term “processor” refers to a hardware computation unit, such as a central processing unit or a microcontroller, that executes instructions of a program to perform data processing, control operations, and communication in the system.

The term “storage unit” refers to a hardware storage resource, such as a memory device or a non-volatile storage device, that stores garment information, user information, product information, purchase information, and program data used by the processor.

The term “information relating to garments” refers to data representing items of clothing associated with a user, including at least one of type, category, size, color, material, usage scene, price, brand, image data, and metadata derived from such attributes.

The term “attribute information of the garments” refers to structured data elements extracted or determined from the information relating to garments, including classification labels, normalized size values, color codes, usage classifications, and other features used for analysis by the processor.

The term “shortage elements of the garments” refers to categories or quantities of clothing items that are determined by the processor to be insufficient for a user, based on comparison between stored garment information and one or more reference criteria, rules, or models.

The term “preference information of a user” refers to data representing the user's likes and dislikes regarding clothing, including at least one of favored colors, favored styles, favored categories, disfavored items, preferred brands, and frequency of use, which is stored and updated by the system.

The term “budget information of the user” refers to data representing monetary constraints of the user, including at least one of maximum price per item, total allowable expenditure for a period, and price ranges acceptable for specific categories of clothing.

The term “prompt sentence” refers to a natural-language or semi-structured text sequence generated by the processor and provided as input to a generative AI model to instruct the model to produce candidate clothing articles or related information.

The term “generative AI model” refers to a machine learning model that generates output data, such as natural-language text or structured data, in response to an input prompt sentence, and that is implemented using an artificial intelligence framework or algorithm configured for generative tasks.

The term “candidate clothing articles” refers to proposed clothing items output by the generative AI model in response to a prompt sentence, each candidate including at least one attribute such as type, style, color, material, and price range.

The term “sales information processing apparatus” refers to a remote computing system, such as an electronic commerce platform or an online retail server, that provides product information, receives purchase requests, and returns transaction results over a communication network.

The term “information communication network” refers to a wired or wireless communication infrastructure, such as the Internet or a mobile data network, that enables data exchange between the server and at least one external device including a sales information processing apparatus and a user terminal.

The term “product attributes” refers to data fields describing a commercial item, including at least one of category, size, color, material, price, brand, rating, availability, and delivery conditions, which are used by the processor for searching and evaluating products.

The term “product information” refers to information obtained from a sales information processing apparatus and describing one or more products, including product attributes, identifiers, pricing data, image references, and sales conditions.

The term “recommended product” refers to at least one product selected by the processor from among a plurality of candidate products, based on comparison and evaluation of product information and correspondence with candidate clothing articles, user preferences, and budget information.

The term “purchase conditions of the user” refers to constraints and rules specified by or derived for the user regarding purchase operations, including at least one of acceptable payment methods, shipping destinations, delivery time requirements, and confirmation requirements.

The term “automatic purchase setting” refers to configuration data that indicates whether and under what constraints the system is permitted to execute purchase processes without explicit confirmation from the user for each transaction.

The term “purchase process” refers to a sequence of operations executed by the processor to place an order for a recommended product with a sales information processing apparatus, including at least one of transmitting product identifiers, payment information, and shipping information, and receiving an order confirmation.

The term “purchase result information” refers to data representing the outcome of a purchase process, including at least one of order identifiers, payment amounts, order status, and estimated delivery dates, which is stored and used by the system.

The term “description information of the candidate clothing articles” refers to textual or structured explanatory content output by the generative AI model for each candidate clothing article, including style descriptions, attribute explanations, and suggested usage contexts.

The term “search conditions” refers to structured query parameters derived by the processor from description information of the candidate clothing articles, including at least one of category restrictions, attribute filters, price ranges, and sorting criteria, and used to request product information from a sales information processing apparatus.

The term “output result of the generative AI model” refers to the generated data returned by the generative AI model in response to a prompt sentence, including candidate clothing articles, their description information, and any associated structured attributes.

In one embodiment, a server cooperates with at least one terminal operated by a user to implement the claimed system. The server comprises a processor, a storage unit, a network interface, and optionally one or more graphics processing units. The terminal comprises a computation unit, a storage resource, an input/output interface, and at least one communication interface. The server executes server-side application software, a database management system, and an inference engine for a generative AI model. The terminal executes a client application that provides a user interface for registering garments, displaying recommendations, and managing purchase settings.

The server uses a relational database management system, such as a general-purpose SQL database, to implement the storage unit. The server stores garment information, user preference information, budget information, AI model output, product information, and purchase result information in structured tables. Typical tables include a garment table, a user table, a preference table, a budget table, an AI recommendation table, a product table, and an order table. Each garment record contains category, standardized size code, standardized color code, material code, usage category code, price value, timestamp, and a reference to associated image data. Each preference record contains encoded style vectors, color preference scores, brand preference scores, and usage frequency statistics. Each AI recommendation record contains a prompt sentence, the corresponding generative AI model identifier, and the resulting candidate clothing articles with their attributes.

The terminal provides a garment registration interface. The user operates the terminal to input garment attributes such as type, size, color, material, usage scene, and price. The terminal may access camera hardware of the terminal to capture an image of a garment and generate an image file. The terminal converts the input into a structured data object, encodes categorical attributes into standardized codes, and transmits the data to the server via a secure communication protocol, such as HTTPS.

The server receives garment data through an application programming interface implemented by a web application framework. The server validates incoming data, normalizes units, maps free-form text to standardized codes using a dictionary and lightweight text normalization algorithms, and stores the normalized data in the garment table. The server may store associated image data in an object storage service or in a file system and record a corresponding identifier in the garment table.

The server analyzes attribute information of the garments using both rule-based logic and learned statistical models to identify shortage elements. The server calculates category-wise counts, usage frequency, and temporal coverage by executing aggregate queries on the garment table and optionally on a usage log table. The server compares these computed statistics with reference profiles stored in a configuration table, such as a profile for a person with a certain occupation, climate, and lifestyle. The server determines shortage elements as those categories or attribute combinations where the computed count or coverage falls below a threshold or deviates from the reference profile beyond a predetermined margin. For example, when the server detects that the user has one pair of business shoes but the reference profile indicates that at least two pairs are recommended for a business environment, the server identifies “business shoes” as a shortage element.

The server maintains preference information and budget information as structured data. The server updates preference information based on user interactions and purchase history. For example, the server computes preference scores for colors and styles by accumulating occurrence counts of attributes of garments that are purchased or frequently used. The server normalizes these counts to produce preference vectors, which are stored in the preference table. The server updates budget information by tracking recent expenditures and user-specified limits, stored as numeric fields representing per-item and per-period budgets.

The server generates a prompt sentence to be input to a generative AI model. The server implements a prompt generator module that constructs a natural-language text string by filling a predefined template with values derived from garment information, shortage elements, preference information, and budget information. The server concatenates a closet summary, shortage description, preference summary, and budget constraints into one coherent prompt sentence.

In one example, the server generates a prompt sentence of the following form:

“The user's closet includes 1 pair of black business shoes, 3 pairs of casual sneakers, 5 business shirts, and 2 suits. The user works in a formal office environment and prefers simple, minimal designs. The budget for new business shoes is 15,000 yen. The user is missing at least 1 additional pair of business shoes suitable for daily commuting and client meetings. Suggest 5 specific types of business shoes, specifying color, material, heel height, and a realistic target price range for each option.”

In another example, the server generates a prompt sentence of the following form:

“The user has only 1 pair of black business shoes but attends formal meetings 4 days a week. The user prefers simple designs and leather materials and has a maximum budget of 15,000 yen. Recommend 3 specific types of business shoes, with suitable colors, materials, and approximate prices.”

The server transmits the prompt sentence to a generative AI model. The server may host the generative AI model on the same physical machine or on a dedicated inference machine comprising a graphics processing unit. The generative AI model may be implemented as a neural network model with an encoder-decoder or transformer architecture. In one embodiment, the generative AI model is a transformer-based language model comprising multiple layers of self-attention and feedforward sublayers, with parameters trained on a large corpus of text. The server may deploy this model using a generic AI framework, such as a tensor computation framework, or may access a remote model through an API.

The server provides the prompt sentence to the generative AI model using a defined input format. The generative AI model receives tokenized input, applies multi-head self-attention to capture relationships between tokens representing closet state, shortage description, and budget constraints, and produces output tokens representing candidate clothing articles and their descriptions. The model may incorporate control tokens or special markers in the prompt to encourage structured output, such as numbered lists or attribute-value patterns.

The server receives the output result of the generative AI model as a text sequence. The server stores the raw output in the AI recommendation table together with the associated prompt sentence and context. The server then parses the output text to extract structured candidate clothing articles. The server uses pattern-matching algorithms and rule-based parsers that search for patterns like “color: X”, “material: Y”, or “price range: A-B” to identify attribute segments. The server converts extracted attributes into standardized codes using the same code dictionaries used for garment normalization.

The server further analyzes description information of the candidate clothing articles to derive search conditions for acquiring product information from one or more sales information processing apparatuses. The server aggregates attribute values across candidates to form query filters for category, color, material, size, and price range. The server creates structured search conditions, such as a set of key-value pairs or query parameters, which are then used to construct requests to remote commerce systems via their application programming interfaces.

The server communicates with each sales information processing apparatus over an information communication network using network interface hardware controlled by the processor. The server sends search requests that include the extracted search conditions. Each sales information processing apparatus returns product information, including product attributes, identifiers, price, availability, ratings, and delivery conditions. The server receives and stores this product information in the product table. The server then compares and evaluates product information from multiple sources.

The server implements a ranking module that computes a score for each product candidate. The ranking module can be a deterministic function, such as a weighted sum of normalized price, rating, and delivery time, or can be implemented as a trained machine learning model. In one embodiment, the server uses a gradient-boosted decision tree model that takes as input features such as price deviation from budget, rating score, number of ratings, match between product color and inferred preference color, and similarity between product description and AI description. The model outputs a relevance score. The server sorts products by score and selects the highest-ranked product or a subset of top-ranked products as recommended products.

The server executes an automatic purchase process when an automatic purchase setting and purchase conditions permit. The server reads the automatic purchase setting from the preference table, and reads user payment tokens and shipping addresses from a secure configuration store. The server then triggers a purchase transaction by sending an order request to a sales information processing apparatus, including product identifier, quantity, shipping address, and payment token. The server receives purchase result information, such as order identifier, final price, and estimated delivery date, and stores this in the order table.

The server notifies the user of the purchase result information by sending a message to the terminal, which then presents it in a graphical interface.

The server updates preference information and budget information based on the purchase result information. The server increments usage and purchase counts for the attributes associated with purchased products, recalculates preference scores, and updates budget usage statistics. The server uses these updated values when generating subsequent prompt sentences. In this way, the server implements a feedback loop in which actual purchase outcomes influence future AI prompts and thus the distribution of candidate clothing articles produced by the generative AI model. This closed-loop adaptive behavior is realized entirely by data processing operations in the server and is not limited to a simple one-time automation of human decision-making.

The server thereby improves computer technology in several ways. First, the server reduces communication load and processing redundancy by automatically transforming high-level, unstructured AI output into structured search conditions without repeated human intervention. Because the server parses AI output once and reuses the resulting search conditions across multiple commerce systems, the server reduces the number of network queries and normalizes product comparison across heterogeneous APIs, improving overall communication efficiency.

Second, the server improves computation efficiency and accuracy in product recommendation by integrating shortage detection, AI-based proposal generation, and product ranking into one coherent data flow. The server uses specialized data structures, such as normalized attribute codes and preference vectors, and machine learning-based ranking to avoid naive exhaustive search. By using learned models to map preference histories and shortage elements into search conditions and scoring criteria, the server reduces search space and improves matching precision.

Third, the server improves data management by enforcing standardized attribute codes and reference profiles throughout garment storage, AI prompting, and product retrieval. This reduces inconsistencies and enables deterministic behavior that is difficult to achieve when users manually search, interpret, and reenter recommendation content. The server thereby lowers error rates in matching garment shortages with actual purchasable products. Fourth, the server uses a generative AI model in a non-conventional manner by tightly coupling it with structured database operations and network protocols. Instead of merely presenting AI output as human-readable suggestions, the server converts AI output into machine-readable parameters, feeds these back into search and ranking pipelines, and updates future AI prompts based on actual outcomes stored in persistent data structures. This architecture goes beyond mere automation of human tasks and results in an adaptive computational system that changes its internal control parameters (preference vectors, budget constraints, and prompt templates) based on objective performance metrics, such as successful purchases and returns.

The terminal supports this architecture by providing standardized input and output interfaces. The user uses the terminal to input garment attributes, manage budgets, approve or restrict automatic purchases, and review recommendation rationales. The terminal displays, for each recommended product, extracted reasons such as “matches your preferred color” or “within your budget and earlier delivery,” which the server computes as part of its ranking logic. The user may override preferences or adjust budgets; the terminal transmits these changes to the server, which stores them and incorporates them into subsequent analyses and prompt sentence generation.

In alternative embodiments, the server may host different types of generative AI models. For example, the server may use a sequence-to-sequence model with recurrent layers, or a hybrid model in which a generative language model is combined with a retrieval component that accesses a catalog of generic garment patterns. The server may also adjust hyperparameters of the generative AI model, such as temperature and top-p, based on user risk tolerance or diversity requirements. These variations still fall within the scope of the described embodiment, as the core concept remains that the server generates prompt sentences using structured internal state, obtains candidate clothing articles from a generative AI model, parses the output to derive search conditions, and links those conditions with product information from external systems.

In further embodiments, the server may implement additional control logic for bandwidth and latency optimization. The server may cache results of frequent queries or partial AI outputs when the same shortage element and similar preferences occur. The server may pre-compute candidate sets for common scenarios and refine them using the most recent budget values and preference updates, thereby reducing the computational cost and network traffic at recommendation time.

Through these hardware-anchored and algorithmically specific operations, the server, the terminal, and the user cooperate so that the server implements an integrated wardrobe management and purchase system that improves the functioning of the computer system itself. The system realizes faster and more accurate matching between garment shortages and purchasable products, reduces communication overhead, and decreases the need for human interpretation of AI output, thereby providing concrete technical effects beyond a mere automation of human decision-making.

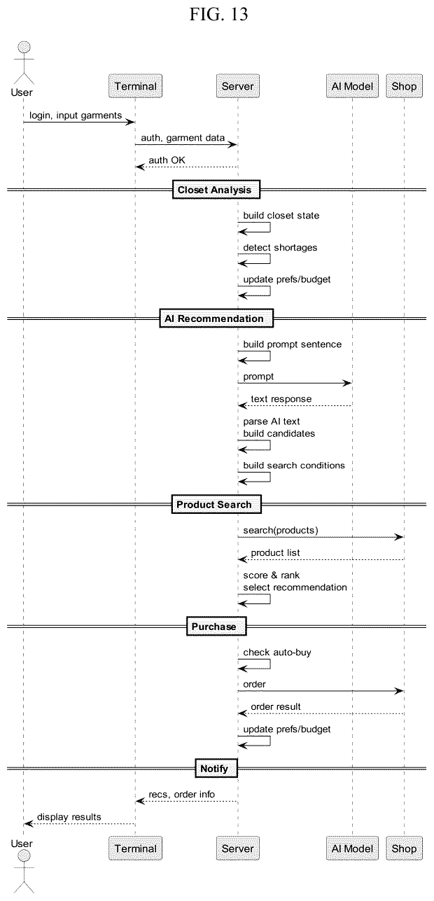

The following describes the processing flow using FIG. 13.

### Step 1:

The user operates the terminal to start a clothing management application and log in. The input is user identification information, such as an email address and password, entered through a graphical user interface. The terminal transmits this identification information to the server via a secure communication protocol. The server receives the identification information, queries a user record stored in a storage unit, and compares a hashed version of the input password with a stored hash value. Based on this comparison, the server outputs an authentication result and an authentication token. The terminal receives the authentication token and stores it in a secure storage area as output, and then uses the token as input for subsequent requests.

### Step 2:

The user operates the terminal to register garments. The input is garment attributes such as type, category, size, color, material, usage scene, price, and optionally a captured image. The terminal converts the raw input into a structured data object by mapping text to predefined attribute fields and by encoding the image into a compressed format. The terminal outputs a normalized garment data object and transmits it to the server together with the authentication token. The server receives the garment data object as input, validates required fields and formats, and maps free-form text to standardized internal codes using lookup tables. The server then outputs normalized garment records stored in a garment table of the storage unit and, if applicable, outputs an image identifier stored in an image storage resource.

### Step 3:

The server periodically reconstructs the current closet state for the user. The input is the set of normalized garment records stored in the garment table associated with the user. The server executes aggregate database queries to compute counts per garment category, distributions of colors and materials, and timestamps of recent registrations. The server performs data aggregation and grouping operations over these records to derive statistics such as “number of business shoes” and “number of suits.” The server outputs a structured closet state representation, for example a data structure containing category-wise counts and attribute distributions, which is stored in a transient memory region for subsequent processing.

### Step 4:

The server identifies shortage elements of the garments. The input is the structured closet state representation from Step 3 and reference profile data stored in a configuration table. The server compares category-wise counts from the closet state with required counts or recommended ranges in the reference profile, and calculates a difference for each category.

The server performs arithmetic subtraction and threshold comparison to detect categories where the actual count is below the required minimum. Based on these computations, the server outputs a shortage list that includes, for each shortage element, a garment category, a shortage quantity, and optional recommended colors or materials. This shortage list is stored in the storage unit and also retained in working memory as output.

### Step 5:

The server maintains and updates preference information and budget information of the user. The input is historical garment records, product purchase history, and explicit preference settings provided by the user through the terminal. The server analyzes these inputs by computing frequency counts of purchased or frequently used attributes, normalizing these counts to generate preference scores, and accumulating expenditure data over configurable time windows. The server performs vector formation and normalization, and computes running sums and averages for budget tracking. The server outputs updated preference vectors and budget values, which are written to a preference table and a budget table and used as inputs for prompt generation.

### Step 6:

The server generates a prompt sentence for a generative AI model. The input is the shortage list from Step 4, the preference vectors and budget values from Step 5, and a summary of the closet state from Step 3. The server executes a prompt construction algorithm that fills a template with textual descriptions of the closet, the shortage elements, the user's style preferences, and budget constraints. The server performs string concatenation, value formatting, and insertion of control phrases that guide the generative AI model to output structured recommendations. The server outputs a complete prompt sentence as a text string.

### Step 7:

The server transmits the prompt sentence to the generative AI model and obtains candidate clothing articles. The input is the prompt sentence from Step 6. The server tokenizes the prompt sentence if the generative AI model is hosted locally, or wraps the prompt sentence in an application programming interface request if the model is accessed remotely. The generative AI model executes neural network computations, including attention and feedforward operations, to generate output tokens representing proposed garment recommendations. The server receives the generated text as output and stores it in an AI recommendation record. Thus, the server outputs an AI-generated description that contains candidate clothing articles and their attributes.

### Step 8:

The server parses the AI-generated description into structured candidate clothing articles. The input is the AI-generated description from Step 7. The server applies pattern-matching rules and token-level parsing to detect attribute expressions such as color indications, material indications, and price ranges. The server uses regular expressions and dictionary lookups to map textual attribute phrases to internal standardized codes and numeric intervals. From this input, the server performs text segmentation, code mapping, and numeric parsing to generate structured candidate records. The server outputs a list of candidate clothing articles, each represented as a data structure containing category, color code, material code, and price range, and stores this list in an AI recommendation table.

### Step 9:

The server derives search conditions for external product search based on the structured candidate clothing articles. The input is the list of candidate clothing articles from Step 8 and the user's size information and budget limits stored in the storage unit. The server aggregates attributes across multiple candidates and selects appropriate ranges and filters, such as category, color, material, size, and maximum price. The server performs set union, intersection, and range intersection operations to merge overlapping attribute constraints. As a result, the server outputs structured search conditions, such as a set of query parameters or filter objects, which are used as inputs for communication with one or more sales information processing apparatuses.

### Step 10:

The server acquires product information from one or more sales information processing apparatuses based on the search conditions. The input is the structured search conditions from Step 9. The server constructs network requests in the format required by each external system, embedding the search conditions as query parameters or request body fields. The server sends these requests over an information communication network and receives responses that contain product information in structured formats. The server parses the responses, performs field extraction and type conversion, and maps external attribute names to internal attribute codes. The server outputs a consolidated product candidate list, which includes product identifiers, attributes, prices, and ratings, and stores this list in the product table.

### Step 11:

The server compares and evaluates product candidates to select at least one recommended product. The input is the consolidated product candidate list from Step 10 and the preference vectors and budget values from Step 5. The server computes a score for each candidate using a scoring function or a machine learning ranking model, which may incorporate features such as price deviation from budget, attribute similarity to candidate clothing articles, user preference alignment, and rating scores. The server executes arithmetic operations, normalization, and, if applicable, model inference to obtain a scalar score for each candidate.

The server then sorts product candidates by score and outputs one or more highest-scoring items as recommended products. These recommended products are stored in a recommendation output structure in the storage unit.

### Step 12:

The server determines whether an automatic purchase process should be executed. The input is the recommended products from Step 11, the automatic purchase setting, and the purchase conditions of the user stored in the storage unit. The server checks logical conditions such as whether automatic purchase is enabled, whether the total price is within user-defined limits, and whether category-specific rules allow automatic ordering. The server performs logical evaluations and comparison operations based on these inputs. As output, the server generates a decision flag indicating either “automatic purchase permitted” or “manual confirmation required,” and associates this flag with each recommended product.

### Step 13:

The server executes an automatic purchase process when permitted. The input is the recommended products and the decision flag from Step 12, together with stored payment tokens and shipping address information. The server constructs an order request that includes product identifier, quantity, destination address, and payment token. The server transmits this request to the selected sales information processing apparatus over the information communication network. The external apparatus processes the order and returns purchase result information such as order identifier, final charge amount, and delivery estimate. The server parses this response, validates success codes, and outputs purchase result information that is stored in the order table and prepared for notification to the user.

### Step 14:

The server updates preference information and budget information based on the purchase result information. The input is the purchase result information from Step 13 and the attributes of the purchased products. The server increments counts of purchased attribute combinations in the preference data structure and recomputes preference scores by normalizing these counts over a sliding time window. The server updates budget usage values by adding the final charge amount and recalculating remaining budget values. The server performs arithmetic accumulation, normalization, and windowed aggregation. The server outputs updated preference vectors and budget values that will be used as inputs for subsequent prompt sentence generation, thus closing the feedback loop.

### Step 15:

The server notifies the terminal of recommendations and purchase results. The input is the recommended products, the decision flag, and any purchase result information associated with automatic purchases. The server composes a notification message that summarizes shortage elements, recommended products, reasons for recommendation, and, when applicable, details of completed orders. The server formats this information into a structured response and transmits it to the terminal over the communication network. The terminal receives the notification, parses the response, and outputs user-readable information on a display. The user then views the recommendations and, if manual confirmation is required, may operate the terminal to issue additional commands such as approving a purchase or adjusting preferences, which become new inputs for the server in subsequent cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented wardrobe management systems mainly register item metadata and present static recommendations based on simple rules. In such systems, images of garments are often stored as unstructured data, and only limited attribute extraction is performed. As a result, the underlying computing resources are not effectively utilized to transform raw image data, user behavior data, and external context data into rich, machine-usable structures. This leads to several technical issues: database structures are under-specified for fine-grained garment attributes and usage histories, recommendation logic is hard-coded and inflexible, and integration with external transaction platforms is ad hoc and error-prone.

Moreover, in known systems, natural language generation and interpretation are typically separated from the core data-processing pipeline. When a separate generative model is used, prompt texts are handcrafted and not systematically derived from the current database state, user context, and external environment. This prevents the computing system from exploiting feedback loops in which model outputs are converted back into structured data that can update internal data stores and drive further automated actions, such as product search, purchase, or listing on external platforms. Consequently, server-side processing becomes fragmented, with increased latency and redundant data transformations across components. Existing systems also do not adequately incorporate user emotion states and environment information into the architecture of the server. Emotion data, when used, is often treated as a superficial label rather than as a parameter that changes prompt construction, model invocation, and subsequent automated actions. This results in recommendation engines that are not context-aware in a computational sense and cannot adapt their internal workflows and resource allocation to different user states or external conditions.

Further, automatic detection of unused garments and automatic listing on transaction platforms is generally implemented through fixed rules and static templates. Such implementations lack a robust mechanism for turning long-term usage histories and seasonality into structured signals that can programmatically control natural language generation, and then use generated language to drive API-level operations. This leads to poor scalability, because any change in listing policies or marketplaces requires manual reprogramming of templates and interface logic.

Accordingly, there is a need for an improved computer-implemented system and server architecture that (i) systematically transforms image data and related attributes into rich management information, (ii) programmatically generates prompt sentences for a generative AI model based on this management information and multi-source context information, (iii) converts natural language outputs from the model into structured data that directly updates a garment management database and controls external transaction interfaces, and (iv) integrates emotion-aware logic and usage-history analysis into the core processing pipeline. Such a system should reduce manual rule-writing and template management, improve the efficiency and accuracy of recommendation and transaction workflows, and provide a technically improved way for the server to orchestrate complex, multi-step operations using generative AI as a functional component of the data-processing architecture.

The specific processing by the specific processing unit 290 of the data processing device 12 in Application Example 2 is realized by the following means.

The present invention provides a server comprising a processor configured to periodically acquire images of garments stored in a storage space by using an image acquisition device and to store the acquired images and associated attribute information in a storage unit of an information processing apparatus; to perform preprocessing and classification processing on the stored images by using an image processing program and a machine learning program, in order to extract feature information representing at least a type, a color, a pattern, a style, a quantity, a usage history, and a seasonality of the garments, and to register the feature information as management information in the storage unit; to generate, in a natural language, a prompt sentence to be input to a generative AI model on the basis of at least a part of the management information and at least one of user attribute information, usage history information, emotion state information, environmental information, and external transaction information, the prompt sentence instructing the generative AI model to perform at least one of proposing a combination of garments, proposing missing garments, selecting candidates for acquisition of garments, and performing unnecessary-garment organization and generation of listing information for a market, and to input the prompt sentence to the generative AI model; to analyze natural language data output from the generative AI model to generate structured data including at least one of coordination proposal information, acquisition candidate information, and listing information, to update a garment management database on the basis of the structured data, and to automatically execute at least one of product searching, product comparison, purchasing processing, and listing processing through a communication interface with an external transaction platform; and to transmit at least one of the coordination proposal information, the acquisition candidate information, and the listing information to a terminal device, to display the information via a user interface on the terminal device, to receive approval input or correction input from a user via the user interface, and to reflect a result of the input in the garment management database and in conditions for generating the prompt sentence to be input to the generative AI model. This enables the computing system to close a technical loop in which image-derived management information, context-aware prompt sentences, and generative model outputs are coherently integrated into the server's data structures and transaction interfaces, thereby improving the efficiency, adaptability, and scalability of wardrobe management, recommendation, and automated transaction processing in the underlying computer architecture.

The term “processor” refers to a hardware and/or software based computation unit, such as a central processing unit or a processing circuit, that executes instructions to perform image processing, data analysis, prompt generation, model invocation, and transaction control operations described in the system.

The term “information processing apparatus” refers to an electronic apparatus including at least one processor, a memory, and communication circuitry, configured to store, process, and transmit data related to garment images, management information, and external transactions.

The term “image acquisition device” refers to a hardware device capable of capturing visual information of garments, such as a camera, an imaging sensor, or an optical capture unit, and outputting corresponding digital image data.

The term “storage space” refers to a physical or virtual area in which garments are kept, such as a closet, wardrobe, cabinet, or other garment holding environment.

The term “garment” refers to a wearable article for covering a human body, including but not limited to tops, bottoms, outerwear, footwear, and accessories.

The term “image” refers to digital data representing visual information of one or more garments captured by the image acquisition device.

The term “storage unit” refers to a memory device or data store, such as a non-volatile memory, a database, or a storage service, used to retain images, attribute information, and management information.

The term “attribute information” refers to metadata associated with an image, including but not limited to capture time, user identifier, tags, or other descriptive data of the garments in the image.

The term “image processing program” refers to executable instructions or software modules configured to perform operations on image data, such as resizing, filtering, segmentation, or feature extraction.

The term “machine learning program” refers to executable instructions implementing a trained model or learning algorithm that processes input data to infer classifications, predictions, or other outputs, such as garment type classification or attribute recognition.

The term “feature information” refers to structured data derived from image analysis, representing properties of garments, such as type, color, pattern, style, quantity, usage history, and seasonality.

The term “management information” refers to organized feature information and related data stored in the storage unit and used for managing garments, including inventory status, usage logs, and classification results.

The term “garment management database” refers to a data structure or database system that stores management information for garments, including identifiers, attributes, usage metrics, and links to transaction records.

The term “usage history” refers to data representing temporal records of when and how often a garment has been worn or used.

The term “seasonality” refers to information indicating suitability of a garment for particular times or seasons, derived from attributes, usage history, and temporal context.

The term “user attribute information” refers to data describing characteristics of a user, including preferences, sizes, demographic information, or style tendencies.

The term “usage history information” refers to aggregated or item-level records of garment usage events for a user, stored in association with the garment management database.

The term “emotion state information” refers to data representing a current or recent emotional condition of a user, such as joy, sadness, stress, or calm, obtained from user input or emotion analysis.

The term “environmental information” refers to contextual data external to the garments and the user, including but not limited to weather information, date and time information, and event schedule information.

The term “external transaction information” refers to data obtained from or related to external transaction platforms, including product data, pricing, availability, review scores, or marketplace status.

The term “generative AI model” refers to a trained machine learning model capable of producing natural language or other content in response to an input prompt sentence, such as a language model used to generate text-based recommendations or listing descriptions.

The term “prompt sentence” refers to a natural language expression or sequence of tokens that encodes an instruction or query to be provided to a generative AI model to control the type, scope, or style of output produced by the model.

The term “coordination proposal information” refers to structured data describing one or more recommended combinations of garments for wear by a user, including references to specific garments and explanatory text.

The term “acquisition candidate information” refers to structured data specifying garments that are proposed to be newly acquired by a user, including category, desired attributes, and associated product candidates.

The term “listing information” refers to data used to register a garment for sale or transfer on a transaction platform, including a listing title, a listing description, a recommended price, and optional category or condition fields.

The term “missing garments” refers to garment types or categories that are determined to be lacking in a user's wardrobe based on management information and preference models.

The term “unnecessary-garment organization” refers to processing to identify garments with low or no usage or mismatched seasonality and to propose actions such as disposal, donation, or listing on a transaction platform.

The term “terminal device” refers to a user-operated device connected to the server via a network, such as a mobile device, a portable terminal, or a general-purpose computing device, configured to display information and accept user input.

The term “user interface” refers to a software-based interaction mechanism, including graphical displays and input controls, through which the user views coordination proposals, acquisition candidates, or listings and provides approval or correction input.

The term “external transaction platform” refers to a remote commerce or marketplace system accessible over a communication network and configured to support product searching, comparison, purchasing, or listing.

The term “communication interface” refers to hardware and/or software components that enable data exchange between the server and external systems, including network interfaces and protocol handlers for application programming interfaces.

The term “approval input” refers to user-provided input indicating consent to perform an action proposed by the system, such as purchasing a garment or listing a garment on a transaction platform.

The term “correction input” refers to user-provided input modifying, adjusting, or overriding information generated by the system, such as editing a listing description or adjusting a recommended outfit.

The term “product searching” refers to an operation in which the server or associated software queries external transaction platforms to retrieve information about items matching specified attributes or criteria.

The term “product comparison” refers to processing that evaluates multiple candidate products based on attributes including price, ratings, delivery conditions, or similarity to a recommended specification.

The term “purchasing processing” refers to automated operations in which the server causes a transaction platform to complete a purchase of a product on behalf of a user, using stored or provided payment and shipping information.

The term “listing processing” refers to automated operations in which the server registers a garment as an item for sale or transfer on a transaction platform, using listing information generated by or obtained through the generative AI model.

The term “emotion-aware garment management processing” refers to a process in which the server adapts coordination proposals, acquisition proposals, or unnecessary-garment organization based on the emotion state information of the user.

In one embodiment, a server cooperates with at least one terminal and with a generative AI model to implement the claimed system. The server includes a processor, a memory, a network interface, and a non-transitory storage device. The terminal includes a processor, a camera, a display, an input interface, and a communication module. The server executes software modules including an image processing module implemented, for example, with a library such as an image-processing framework, a machine learning module implemented, for example, with a framework such as a neural-network library, and a generative-model interface module configured to communicate with at least one external or internal generative AI model.

The server stores, in the storage device, a garment management database. The garment management database includes, for example, a garment table, a user table, a usage-history table, a listing table, and an emotion-state table. The garment table includes fields such as: garment identifier, user identifier, garment category, main color, pattern type, style type, size, brand, seasonality code, usage-frequency metrics, and links to one or more image records. The usage-history table includes fields such as: garment identifier, date-time stamp, usage context, and optionally weather conditions and user emotion at the time of usage. The server maintains referential integrity between these tables to enable efficient querying and updating. The terminal acquires images of garments stored in a storage space by using the camera. The terminal associates metadata such as capture time, user identifier, and optional manual tags with each captured image. The terminal transmits the image data and associated metadata to the server through a network connection using a secure protocol. The terminal also provides user interface screens that allow the user to confirm images, input or edit garment attributes (such as size or purchase date), and input or select an emotion state (such as joy, sadness, or stress).

The server receives the images and metadata through the network interface and stores the raw image data in an image store, for example in an object storage service or a file system. The server registers a reference to each stored image and its metadata in an image table within the garment management database. The server then executes an image preprocessing pipeline on each new image. The server applies operations including resizing to a canonical resolution, color-space conversion, normalization, background segmentation, and optional data augmentation such as random cropping and flipping. These operations are implemented by the image processing module and are parameterized so that images are standardized in a way that reduces noise and improves downstream classification accuracy.

The server executes a trained convolutional neural network as part of the machine learning module to classify garment type and extract attributes. In one embodiment, the server uses a deep convolutional architecture having multiple convolutional layers, pooling layers, and fully connected layers, trained on a dataset of labeled garment images. The server uses this network to output probability distributions over garment categories (for example, shirt, coat, trousers, shoes, accessory) and to output intermediate feature vectors representing visual characteristics such as color histograms, texture descriptors, and shape descriptors. The server maps these outputs to discrete fields stored in the garment table, such as category code, color code, and pattern code, using pre-defined mapping tables.

The server also computes seasonality and initial usage metrics. The server calculates seasonality using a rule-based mapping from garment category and material (inferred from visual features) to season codes such as spring, summer, autumn, and winter. The server initializes a usage-frequency metric to zero for new garments and links each garment record to a usage-history list that will be populated when the terminal uploads wear logs. The server maintains these computed attributes as management information in the garment management database.

The terminal supports a daily logging function in which the user selects garments worn on a given day. The terminal transmits usage events including garment identifiers and timestamps to the server. The server records these events in the usage-history table and updates cumulative usage-frequency metrics in the garment table. The server computes derived metrics such as last-worn date and number of wears in the last specified period. The server may also correlate usage events with external environmental data such as weather information obtained from an external weather information source, so that the server can refine seasonality estimates with observed usage patterns.

The server executes an analysis routine to identify missing garments and unnecessary garments. The server uses queries over the garment management database to compute the distribution of garment categories, styles, and colors for each user. The server compares this distribution to predefined or learned target distributions. For example, the server may store in a configuration table that a business user should own at least two pairs of business shoes and at least a certain number of shirts. When the actual inventory is below the target, the server records a missing-garment candidate. Likewise, the server examines usage-frequency metrics and last-worn dates. When a garment has not been worn for a predetermined time or has low relative usage compared to other similar garments, the server flags the garment as an unnecessary-garment candidate.

The server generates prompt sentences for a generative AI model by programmatically traversing the garment management database and user-related tables. The server constructs prompt sentences in a natural language using templates and dynamic insertion of values from the database. For example, the server may generate the prompt sentence:

“The user has only one pair of business shoes. The user's budget is 10,000 yen and the user prefers classic black designs. Propose three suitable business shoes with short reasons.”

The server may also generate a prompt sentence for listing information such as:

“The user has a women's medium beige trench coat, lightly used, last worn over two years ago, suitable for spring and autumn. Create an attractive marketplace listing title and a three to four sentence description.”

The server may generate a prompt sentence for emotion-aware coordination such as:

“The user feels stressed today. The user's closet includes three casual T-shirts, two hoodies, one pair of jeans, and one pair of joggers. Today's weather is cloudy and cool. Suggest one comfortable, stress-relieving outfit using existing items only, and explain why the outfit is appropriate.”

The server uses a generative-model interface module to send the prompt sentences to a generative AI model. In one implementation, the generative AI model is a transformer-based language model that has been previously trained on a large corpus of text and optionally fine-tuned on garment-related and marketplace-related text. The server transmits each prompt sentence as a text string via an application programming interface and receives a natural-language response. The response may include recommended combinations of garments, recommended new products with attribute descriptions, or listing titles and descriptions.

The server parses the generative AI model output into structured data. The server uses natural-language parsing rules and pattern matching to extract garment categories, colors, and other attributes from the text. For example, when the generative AI model outputs “black leather oxford shoes within 10,000 yen,” the server identifies “business shoes” as the category, “black” as the color, “leather” as the material, and “oxford” as the style. The server stores this information in an acquisition candidate table. When the generative AI model outputs a listing title and description, the server stores these strings in the listing table associated with a specific garment identifier.

The server integrates with external transaction platforms by using their network interfaces.

The server generates search requests based on structured candidate data derived from the generative AI model responses. The server transmits product search queries that include constraints such as category, price range, color, style, and user preferences. The server receives search results in structured formats and applies ranking algorithms. The server may calculate scores using a weighted combination of price, rating, delivery time, and similarity between external product attributes and the recommendation description from the generative AI model. The server stores and updates acquisition candidate information in the garment management database.

The terminal displays coordination proposals, acquisition candidates, and listing information to the user. The terminal receives structured data and corresponding natural-language explanations from the server and presents them on the display. The terminal shows, for example, an outfit suggestion including references to specific garments in the closet, a list of recommended products, or a preview of a marketplace listing. The user interacts with these screens to approve or modify proposed actions. The terminal transmits approval input or correction input to the server, which the server then uses to update the garment management database and to refine subsequent prompt generation.

The server processes emotion-state information in a technically specific manner. In one embodiment, the server receives raw text describing the user's mood or receives a discrete label selected in the terminal. In another embodiment, the server receives voice data and applies an acoustic model to derive emotion features such as pitch variability and spectral characteristics. The server stores the resulting emotion-state labels and confidence scores in the emotion-state table. The server uses these labels as parameters when building prompt sentences and when choosing which type of operation to prioritize, such as recommending soothing outfits versus suggesting decluttering actions.

The server implements the machine learning module for image analysis using a deep neural network with a specified architecture. The server initializes a network having convolutional layers, batch-normalization layers, non-linear activation functions, pooling layers, and at least one fully connected layer that outputs class probabilities and feature vectors. The server trains this network using supervised learning on labeled garment image data. The server computes a loss function such as a cross-entropy loss between predicted class distributions and ground-truth labels, optionally combined with auxiliary losses for color or pattern prediction. The server updates the network weights using a gradient-based optimizer. In addition, the server performs data augmentation such as random cropping, horizontal flipping, color jittering, and random rotation during training to enhance robustness. The server deploys the trained network in inference mode to classify incoming garment images with improved accuracy and robustness compared to simpler rule-based systems.

The server improves computational efficiency by combining intermediate features and caching management information. The server computes feature vectors once and stores them in the garment management database, so that repeated modeling and recommendation computations can reuse these vectors rather than recomputing image features from raw images. The server indexes the database on commonly queried fields such as garment category and usage metrics to support efficient retrieval. This arrangement reduces processing time and network load when constructing prompt sentences and evaluating candidate garments.

The server improves precision and reduces errors in garment classification, recommendation, and listing text generation by integrating structured attribute extraction with generative modeling. The server does not simply use generative AI as a standalone content engine. Instead, the server systematically constrains and guides the generative AI model by embedding precise management information and context into each prompt sentence. The server also restricts how it uses generative model outputs by parsing and validating them before updating internal data structures or calling external transaction APIs. By doing so, the server increases transaction safety and consistency compared to systems that directly forward generative text to external platforms without structured validation.

The server implements a prompt-generation module that uses non-conventional rules and templates. The server considers not only the current closet state but also temporal context, external environmental information, and emotion-state information. For example, the server may adopt rules that modify prompt style depending on the detected emotion: a calming, reassuring tone for stress-related prompts, or an enthusiastic tone for joy-related purchase suggestions. These prompt variations are not mere textual decoration. They influence the generative AI model's output distribution, resulting in technically different recommendation data that is tailored to user context. The server dynamically selects templates and weightings for different information types when constructing prompt sentences. This selection process is implemented as a set of algorithmic steps that evaluate confidence in garment attributes, variance in usage metrics, and uncertainty in emotion-state labels. The server applies these steps independently of human intervention, thus achieving a programmatic adaptation that improves relevance and reduces recommendation noise.

The server, by orchestrating image processing, machine learning, generative text processing, and external transaction control in an integrated data flow, provides technical improvements beyond simple automation of human decision-making. The server reduces computation time by caching and reusing derived features, uses less network bandwidth by transmitting structured summaries rather than raw images where possible, and improves data management by maintaining coherent, normalized representations of garments and transactions. The server reduces error rates in garment classification and marketplace listing generation through iterative training and by combining machine-learned predictions with rule-based checks. These improvements directly relate to the functioning of the computer system and its subcomponents rather than merely implementing an abstract business practice.

Alternative embodiments are possible within the scope of the claims. The server may execute the generative AI model locally instead of via a remote interface. In such a case, the server loads a language model into local memory, and the processor executes attention-based operations of the transformer architecture to generate text in response to prompt sentences.

The server may also employ different network architectures for image analysis, such as residual networks or attention-based vision models, while still performing the same functional sequence of feature extraction and management information registration. The terminal may be a handheld device, a wearable device such as smart glasses, or a general-purpose computing device. The external transaction platform may be any system that provides standardized interfaces for product search, purchase, or listing.

In another embodiment, the server maintains multiple generative AI models specialized for different tasks, such as a coordination model, a purchase-suggestion model, and a listing-generation model. The server selects which model to invoke based on the type of prompt sentence it has constructed. The server may also maintain different prompt-construction policies for different user groups, using stored feedback data to adapt policies over time. In this manner, the server learns to allocate computational resources and adjust model parameters in a way that optimizes overall system performance.

In all embodiments, the server maintains the central role in managing data structures, executing machine-learning inference, generating and interpreting prompt sentences for a generative AI model, and controlling external interfaces. The terminal and user provide input and receive output, but the technical processing that transforms raw images and contextual data into actionable, structured operations is performed by the server according to the detailed algorithms and data flows described above. This arrangement ensures that another person skilled in the art can implement the invention and can appreciate how the claimed system produces technical effects, such as increased processing efficiency, improved data quality, and more reliable integration with external transaction platforms.

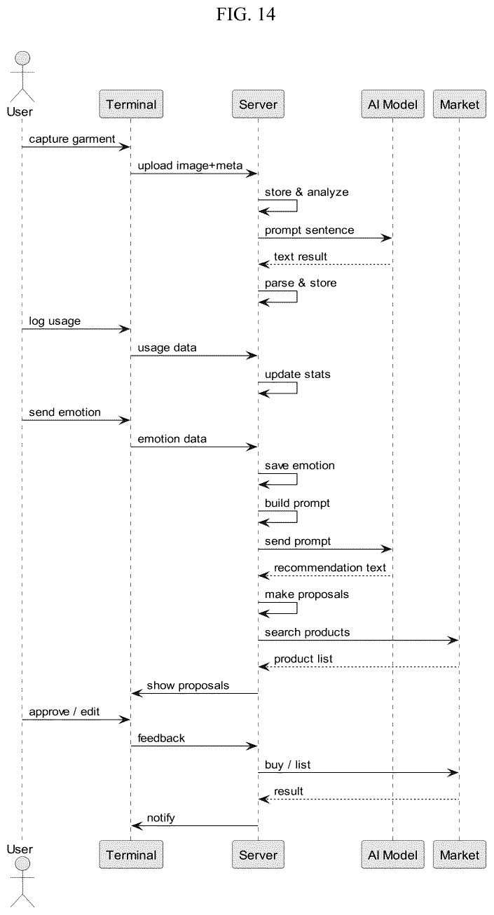

The following describes the processing flow using FIG. 14.

### Step 1:

User operates the terminal to capture garment images.

User opens a wardrobe application on the terminal, positions the camera toward a garment or a storage space, and presses a capture button to take an image.

Input: a physical garment or storage space viewed by the camera.

Output: a digital image file (for example, JPEG) and associated local metadata (timestamp, temporary file path).

Terminal converts the optical signal received by the camera into pixel data, encodes the pixel data into an image file, attaches a timestamp and a provisional garment label if entered by the user, and stores this data in a temporary storage area.

### Step 2:

Terminal transmits garment images and metadata to the server.

Terminal establishes a secure network connection, packages the captured image file and metadata (user identifier, capture time, optional user-entered tags) into a request message, and sends the message to the server through an application programming interface.

Input: local image file and metadata stored on the terminal.

Output: a network request containing binary image data and structured metadata delivered to the server.

Terminal performs data compression if necessary, serializes metadata into a structured format, and uses a secure transport protocol to transmit the request to a predefined server endpoint.

### Step 3:

Server receives and stores raw image data.

Server accepts the incoming request via a network interface, verifies user authentication, and writes the image payload into an image storage system while recording references in a database.

Input: network request containing image data and associated metadata.

Output: a persistent image record identifier and database entries linking the image to a user and storage location.

Server parses the request, extracts the binary image stream and metadata, stores the image in non-volatile storage with a generated file path, and inserts rows into an image table including user identifier, file path, timestamp, and any user-specified tags.

### Step 4:

Server preprocesses images for analysis.

Server loads the stored image from the image storage system, converts it to a standardized size and format, and applies image enhancement filters.

Input: stored image record (file path) and raw pixel data.

Output: a normalized image tensor suitable for machine learning processing.

Server executes an image processing program that resizes images to a uniform resolution, converts color space, normalizes pixel intensity values, and optionally performs background segmentation to isolate the garment, thereby producing a numeric array that is fed to a machine learning program.

### Step 5:

Server performs garment classification and attribute extraction.

Server runs a trained convolutional neural network on the normalized image tensor to infer garment category and visual attributes such as color, pattern, and style.

Input: normalized image tensor produced in Step 4.

Output: classification probabilities for garment categories and a feature vector representing visual attributes.

Server performs forward propagation through multiple convolutional, pooling, and fully connected layers, computes activations using non-linear functions, and obtains a probability distribution over predefined garment classes and a dense feature vector capturing color and texture patterns, which it then decodes into discrete attribute codes.

### Step 6:

Server registers management information in the garment management database.

Server converts classification results into standardized attribute codes and writes them into database tables associated with the garment and user.

Input: garment category probabilities, attribute codes, and feature vectors from Step 5, along with user identifier and image identifier.

Output: one or more rows in garment and related tables containing structured management information.

Server selects the highest-probability category, maps color and pattern features to corresponding codes, initializes usage-frequency fields, estimates seasonality based on category and inferred material, and stores these values in the garment table while linking to the original image record and user record.

### Step 7:

User records garment usage events via the terminal.

User opens a daily usage screen on the terminal, selects garments worn from a list, and confirms the selection to log the day's usage.

Input: list of garment identifiers presented on the terminal and user selections indicating worn items.

Output: a set of usage event records transmitted to the server.

Terminal collects the selected garment identifiers, attaches a current timestamp and user identifier, and sends these usage records as structured data to the server through an application programming interface.

### Step 8:

Server updates usage history and derived metrics.

Server receives usage events, appends them to a usage-history table, and updates summary usage metrics such as last-worn date and wear count.

Input: structured usage events containing garment identifiers, user identifier, and timestamps.

Output: updated usage-history records and updated usage metrics in the garment management database.

Server performs database insert operations to store each event, calculates new wear counts by incrementing existing values, sets or updates the last-worn timestamp for each garment, and computes time intervals since last use for subsequent analysis.

### Step 9:

Server determines missing garments based on inventory distribution.

Server analyzes the garment management database for each user to detect underrepresented garment categories relative to predefined or learned target distributions.

Input: garment records for a user, including categories, counts, and user profile information.

Output: a list of missing-garment candidates with required categories, preferred attributes, and budget ranges.

Server executes aggregation queries to count garments by category and compares the counts to threshold values defined in configuration data or learned models; when counts fall below the threshold, the server records missing-garment candidates, attaches inferred style preferences from past purchases, and estimates a budget from stored price information.

### Step 10:

Server identifies unnecessary garments using usage history and seasonality.

Server inspects usage-history and seasonality fields to determine garments that are rarely or no longer used and classifies them as unnecessary-garment candidates.

Input: usage metrics (wear count, last-worn date) and seasonality codes for each garment.

Output: a list of unnecessary-garment candidates flagged for organization or potential listing. Server computes time since last use by subtracting last-worn timestamps from the current date, compares wear counts against usage thresholds, and applies rules that mark garments as unnecessary when they have not been worn for a predetermined period or are substantially less used than similar garments; the server then stores flags and candidate lists in dedicated tables.

### Step 11:

User provides emotion-state input via the terminal.

User interacts with an emotion input screen on the terminal to select or describe a current emotional state, and then sends the input to the server.

Input: user-selected emotion label or text description entered on the terminal.

Output: an emotion-state message transmitted to the server.

Terminal captures the emotion label or text, associates it with a timestamp and user identifier, and sends the structured emotion data to the server using a designated endpoint.

### Step 12:

Server records and interprets emotion-state information.

Server stores the received emotion-state data and, if necessary, applies an emotion-analysis model to classify free-text descriptions or signals into discrete emotion categories.

Input: raw emotion input (label or text) along with user identifier and timestamp.

Output: a normalized emotion-state record with a standardized category and optional confidence score.

Server writes the raw data into an emotion-state table, processes free-text or other signals through a classifier to assign standardized categories such as “joyful,” “sad,” or “stressed,” calculates confidence values, and saves the normalized label for use in later decision-making.

### Step 13:

Server constructs context-aware prompt sentences for the generative AI model.

Server composes natural-language prompt sentences by combining garment management information, missing-garment lists, unnecessary-garment lists, emotion-state data, and environmental information into text instructions.

Input: management information (garment attributes and usage metrics), candidate lists, emotion-state records, and environmental data such as weather or date.

Output: one or more prompt sentences formulated in natural language.

Server selects a prompt template according to the intended operation (coordination, purchase recommendation, or listing generation), fills template slots with up-to-date values from the database such as number of business shoes, budget, and emotion labels, and concatenates these components into grammatically coherent text instructions, for example: “The user has only one pair of business shoes. The user's budget is 10,000 yen and the user prefers classic black designs. Propose three suitable business shoes with short reasons.”

### Step 14:

Server sends prompt sentences to the generative AI model and obtains responses.

Server uses a generative-model interface to transmit prompt sentences to the generative AI model, waits for the model to generate responses, and receives the resulting natural-language outputs.

Input: text-based prompt sentences produced in Step 13.

Output: natural-language responses from the generative AI model containing recommendations or listing texts.

Server packages each prompt sentence into a request payload, calls a model inference endpoint, monitors the connection for completion, and receives textual outputs such as lists of recommended garments, outfit suggestions, or marketplace listing descriptions.

### Step 15:

Server parses generative-model outputs into structured recommendation data.

Server analyzes the natural-language responses to extract structured information suitable for storage and further processing, such as garment attributes, product descriptions, and listing parameters.

Input: generative AI model responses containing free-form text.

Output: structured recommendation data such as coordination proposals, acquisition candidates, or listing data records.

Server applies parsing rules and pattern-matching techniques to identify item names, colors, price ranges, style descriptors, and suggested actions; the server maps textual phrases into discrete codes or numeric fields, constructs data objects representing each recommendation, and stores these objects in corresponding tables.

### Step 16:

Server updates the garment management database with recommendation results.

Server writes parsed recommendation data into the garment management database, linking new records to existing garment and user records.

Input: structured recommendation data from Step 15, including references to specific garments or categories.

Output: updated database entries for coordination proposals, acquisition candidates, and listing information.

Server inserts new rows into coordination tables that reference garment identifiers, populates acquisition candidate tables with recommended categories and attributes, and associates generated listing titles and descriptions with unnecessary-garment candidates, thereby enriching the database with actionable records.

### Step 17:

Server searches external transaction platforms for acquisition candidates.

Server uses acquisition candidate information to construct search queries for external transaction platforms, transmits these queries, and receives product result sets.

Input: acquisition candidate records specifying desired garment categories, attributes, and budget constraints.

Output: lists of external product offerings matching candidate specifications.

Server forms query parameters from candidate attributes (for example, “black business shoes, classic style, under 10,000 yen”), sends them through a communication interface to external platforms, processes returned product lists, and temporarily stores product identifiers, prices, ratings, and other metadata.

### Step 18:

Server ranks external products and selects final recommendations.

Server evaluates the received product offerings using scoring criteria and selects the most suitable items as final recommendations.

Input: raw product result sets from external platforms and internal scoring rules or models.

Output: a ranked list of recommended products linked to acquisition candidate records.

Server calculates scores for each product by combining factors such as price, user reviews, delivery conditions, and similarity between external product attributes and specification data derived from generative-model outputs; the server sorts products by score, selects top-ranked items, and saves them as recommended products in the acquisition candidate table.

### Step 19:

Server prepares coordination, acquisition, and listing information for display.

Server aggregates updated coordination proposals, recommended products, and listing suggestions for each user session and packages them into response messages for the terminal.

Input: database records for current coordination proposals, acquisition candidates, and listing information associated with a user.

Output: structured response payloads containing display-ready information and explanatory text.

Server gathers relevant records by querying the garment management database, combines them with any explanatory texts from the generative AI model, formats them into a hierarchical structure suitable for UI rendering, and prepares response messages for transmission.

### Step 20:

Terminal displays proposals and suggestions to the user.

Terminal receives the response payload from the server and renders outfit proposals, recommended purchases, and listing previews on the display.

Input: structured response messages containing coordination, acquisition, and listing data, along with explanatory natural-language text.

Output: visual screens presenting proposals and action buttons to the user.

Terminal parses the payload, creates interface components such as garment thumbnails, description text blocks, and approval buttons, organizes these elements on the screen, and updates the display so that the user can review and interact with the suggestions.

### Step 21:

User approves, modifies, or rejects system proposals.

User interacts with the displayed information to indicate acceptance, correction, or rejection of coordination suggestions, purchase candidates, or listing texts.

Input: on-screen proposals and interactive controls presented on the terminal.

Output: user input events such as approvals, edits, and rejections transmitted to the server.

User taps approval buttons for selected items, edits listing text fields as needed, or dismisses unwanted suggestions; the terminal captures these events, converts them into structured commands, and sends them back to the server for processing.

### Step 22:

Server processes user feedback and updates records.

Server receives user approvals and corrections, applies them to the garment management database, and adjusts future prompt-generation conditions.

Input: feedback messages containing approval flags, edited texts, and rejected proposal identifiers.

Output: updated database records and revised parameters for subsequent prompt sentence construction.

Server updates coordination tables to mark accepted proposals, replaces generated listing descriptions with user-edited versions, removes or deactivates rejected candidates, and logs feedback as training or configuration data that influences weightings and rule selections in future prompt construction and recommendation logic.

### Step 23:

Server executes automatic purchase or listing operations.

Server initiates external operations such as purchasing recommended products or creating listings for unnecessary garments based on user approvals.

Input: approved acquisition candidate records, approved listing information, and stored user transaction preferences.

Output: completed or initiated transactions on external platforms and corresponding transaction records in the database.

Server formulates purchase or listing requests using approved data, sends these requests through the communication interface to external transaction platforms, monitors responses for success or failure, records transaction identifiers and statuses, and updates garment records to reflect new acquisitions or active listings.

### Step 24:

Terminal notifies the user of transaction results and status changes.

Terminal receives transaction status updates from the server and displays notifications indicating completed purchases, active listings, or errors.

Input: server messages reporting transaction outcomes and updated garment statuses.

Output: on-screen notifications and updated UI elements indicating wardrobe changes and marketplace actions.

Terminal presents messages such as “Purchased black business shoes for 9,800 yen” or “Beige trench coat has been listed in the marketplace,” updates garment icons to show “incoming” or “listed” states, and allows the user to review transaction details on demand.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

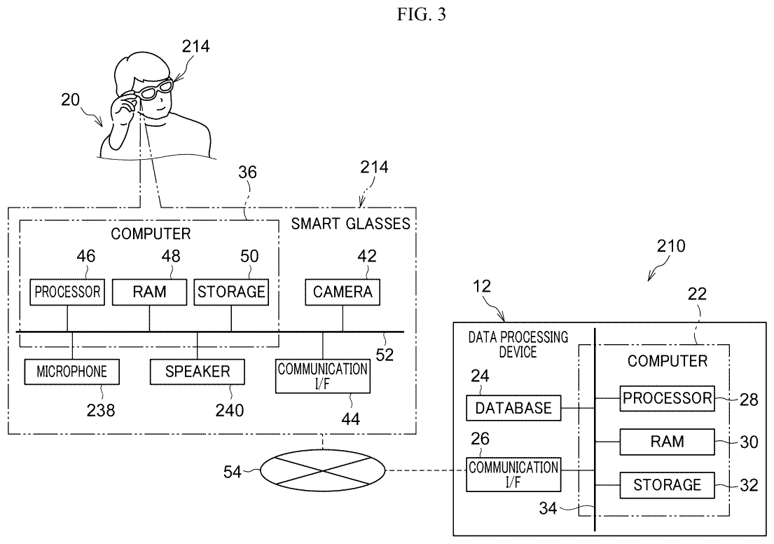

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

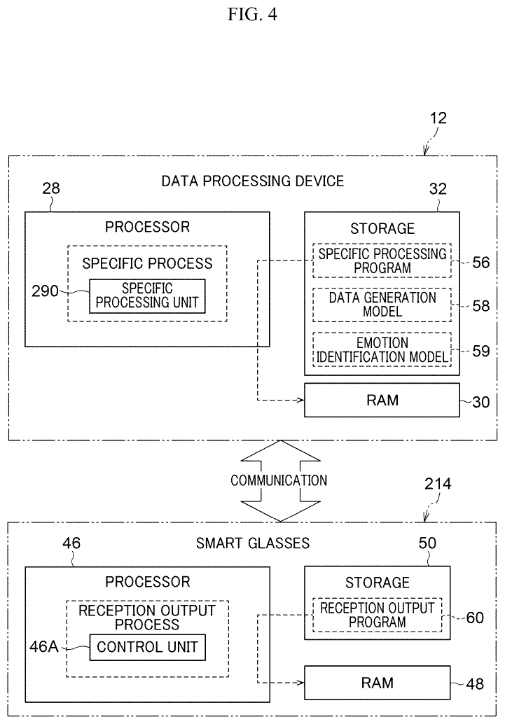

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

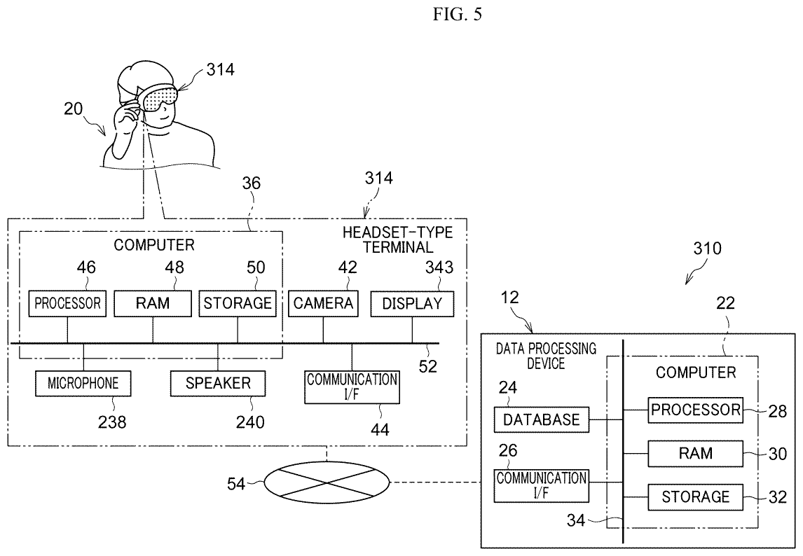

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

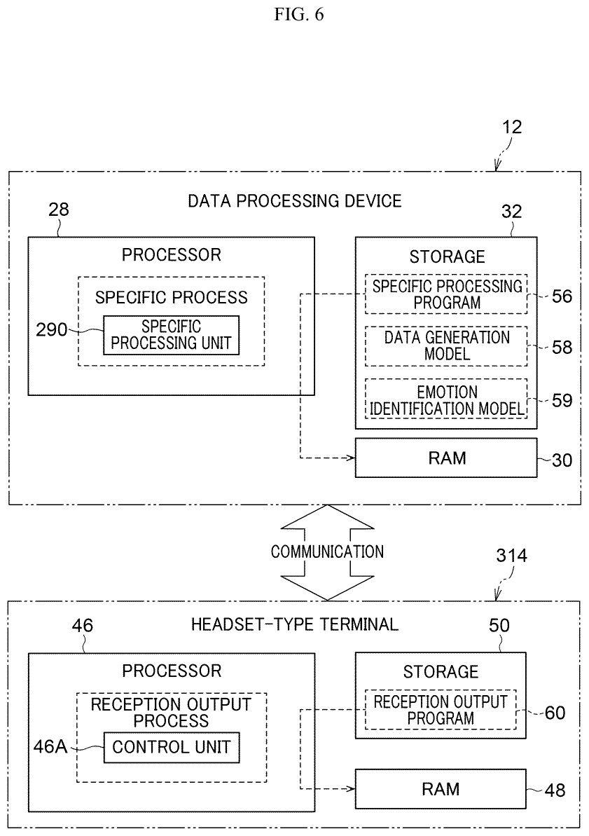

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

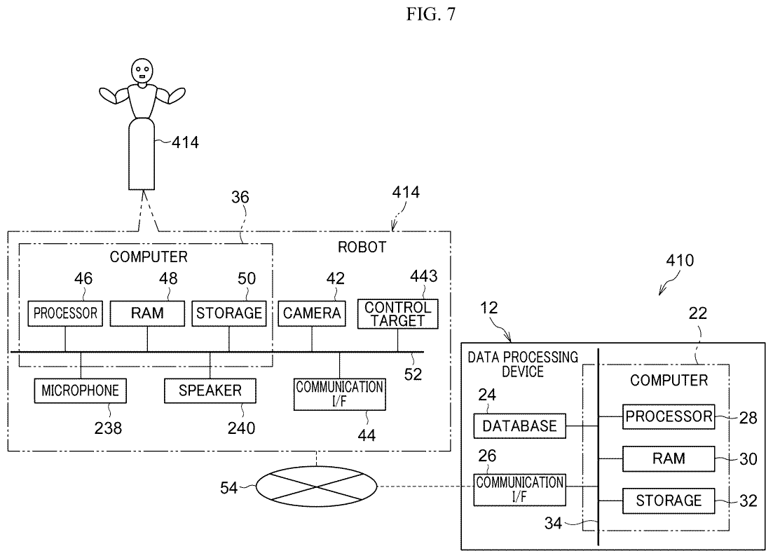

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

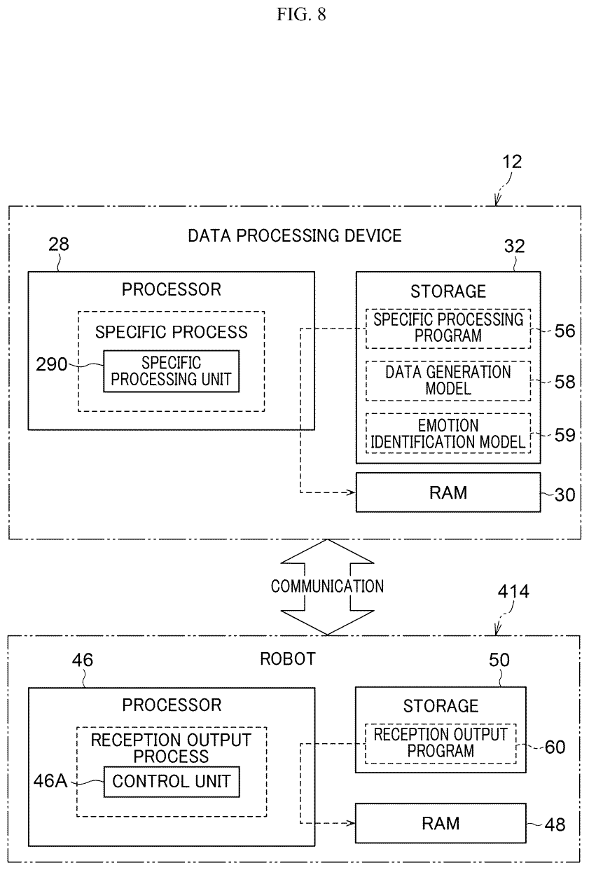

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

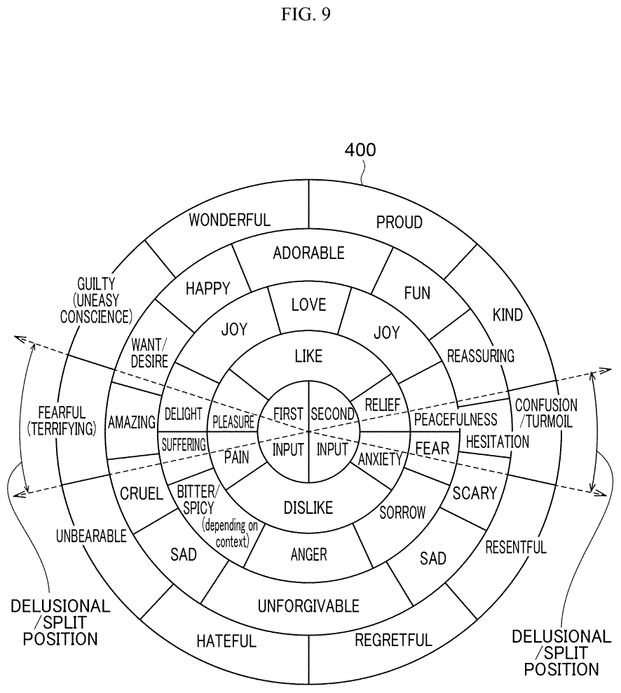

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

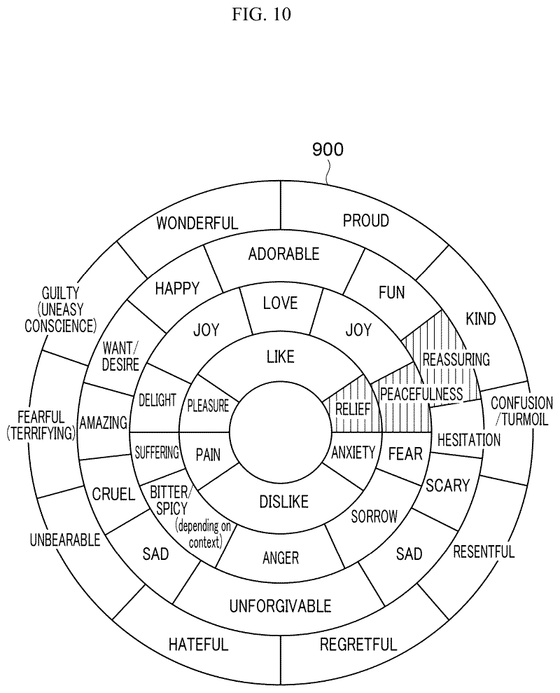

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, and a communication interface,
wherein the processor is configured to control a portable information terminal to acquire an image of an article of clothing using an imaging function of the portable information terminal, and to store the acquired image in a storage area of the portable information terminal,
wherein the processor is configured to transmit, via a communication network and through the communication interface, the image of the article of clothing and attribute information associated with the image from the portable information terminal to a computing apparatus, to store the image in an external storage device of the computing apparatus, to input the image into an information processing program including an image recognition program and a generative artificial intelligence model, to extract, from the image, feature information indicating a type, a color, a pattern, and a style of the article of clothing, and to accumulate the extracted feature information as clothing management data in the storage device,
wherein the processor is configured to, in the computing apparatus, generate, by execution of a computation process, a plurality of candidate combinations of articles of clothing based on the clothing management data, weather information acquired from an external information providing apparatus, and schedule information acquired from a schedule management information processing apparatus, to generate text data describing an internal state including the candidate combinations of articles of clothing, to provide the text data as a prompt sentence to the generative artificial intelligence model, and to cause the generative artificial intelligence model to generate, in natural language, clothing combination proposal sentences that take into account the weather information and the schedule information, and to generate structured data in which the clothing combination proposal sentences are associated with the clothing management data,
wherein the processor is configured to transmit the structured data from the computing apparatus to the portable information terminal, and to control a display device of the portable information terminal to display a user interface including the image of the article of clothing and the clothing combination proposal sentences, and to transmit, from the portable information terminal to the computing apparatus, a selection result in response to a selection operation by a user, and
wherein the processor is configured to accumulate, in the storage device of the computing apparatus, the selection result, the weather information, and the schedule information as history information, and to execute a learning process that updates at least a part of the computation process for generating the candidate combinations of articles of clothing and a process for generating the prompt sentence by using the history information.

### (Supplementary 2)

The system according to supplementary 1,
wherein the processor is configured to calculate, based on the selection result included in the history information, an evaluation value indicating a preference degree of the user, to associate the evaluation value with the clothing management data as clothing attribute data, and to generate the prompt sentence for instructing the generative artificial intelligence model to propose a clothing combination optimized for the user, based on the clothing attribute data including the evaluation value, the weather information, and the schedule information, and to cause the generative artificial intelligence model to generate, in response to the prompt sentence, a proposal sentence in natural language that differs for each user.

### (Supplementary 3)

The system according to supplementary 1,
wherein the processor is configured to calculate, based on the clothing management data and the history information, indices indicating a usage frequency, an elapsed time, and a seasonal suitability for each article of clothing, to extract as unnecessary-item candidates the articles of clothing for which the indices satisfy a predetermined condition, to generate, as a prompt sentence, text data including attribute data and state data relating to the unnecessary-item candidates, and to input the prompt sentence to the generative artificial intelligence model so as to cause the generative artificial intelligence model to generate, in natural language, a proposal sentence indicating a method of organizing the unnecessary-item candidates or listing information for a transaction market and listing data, and to control execution of an automatic listing process to a transaction server based on the listing data.

### Application Example 1

### (Supplementary 1)

A system comprising a processor,
wherein the processor is configured to
acquire image data of wearable articles via an image input device and store the image data in a storage device within an information processing apparatus,
execute an image processing program on the stored image data to extract feature information of the wearable articles including at least a category, a color, a pattern, and a style, and update a user-specific owned-article information storage area that manages the feature information on a per-user basis,
obtain the feature information stored in the user-specific owned-article information storage area and attribute information of merchandise stored in an external merchandise information storage device, and convert both types of information into a data structure that enables association between the owned articles and the merchandise,
generate a prompt sentence including coordination generation conditions and constraint conditions for combining wearable articles owned by a user and the merchandise, based on information acquired from the user-specific owned-article information storage area and the merchandise information storage device, and control input of the prompt sentence into a generative AI model,
obtain a coordination proposal from the generative AI model, re-match the coordination proposal with the user-specific owned-article information storage area and the merchandise information storage device to verify validity of the coordination proposal, and format the coordination proposal as structured data based on a result of the verification, and
acquire images corresponding to the wearable articles and the merchandise included in the formatted coordination proposal and perform display control to present, on a display device, a coordination suggestion including the owned articles and the merchandise to the user.

### (Supplementary 2)

The system according to supplementary 1,
wherein the processor is configured to
refer to a user preference information storage area and a selection history recording area that store user preferences, usage purposes, budget information, and past coordination selection histories, add preference conditions and weighting information corresponding to the user to the prompt sentence, and generate the prompt sentence so as to instruct the generative AI model to generate the coordination proposal in consideration of the preference conditions.

### (Supplementary 3)

The system according to supplementary 1,
wherein the processor is configured to calculate usage status indices including at least a number of wearings, an unused period, and a seasonal attribute of each wearable article based on the stored image data and the feature information stored in the user-specific owned-article information storage area, extract unnecessary article candidates according to the usage status indices, and generate a prompt sentence for input to the generative AI model to cause the generative AI model to generate proposal content including at least an organization method, a disposal method, or listing content for a market with respect to the unnecessary article candidates.

### Example 2

### (Supplementary 1)

A system comprising a processor and a storage unit,
wherein the processor is configured to
acquire information relating to garments and store the information in the storage unit, analyze attribute information of the garments based on the information stored in the storage unit and identify shortage elements of the garments,
generate a prompt sentence for causing a generative AI model to propose candidate clothing articles that complement the shortage elements based on the shortage elements, preference information of a user, and budget information of the user, and input the prompt sentence to the generative AI model,
acquire product information from a sales information processing apparatus over an information communication network based on product attributes corresponding to the candidate clothing articles output from the generative AI model, and compare and evaluate the product information to select a recommended product, and
execute, in accordance with purchase conditions of the user and an automatic purchase setting, a purchase process for the recommended product with respect to the sales information processing apparatus automatically, and notify the user of purchase result information.

### (Supplementary 2)

The system according to supplementary 1,
wherein the processor is configured to update the preference information and the budget information of the user based on the information relating to garments stored in the storage unit and the purchase result information, and dynamically modify the prompt sentence based on the updated preference information and budget information.

### (Supplementary 3)

The system according to supplementary 1,
wherein the processor is configured to analyze description information of the candidate clothing articles output from the generative AI model, extract search conditions from the description information, and use the search conditions for acquiring the product information, thereby linking an output result of the generative AI model with the product information acquired from the sales information processing apparatus over the information communication network.

### Application Example 2

### (Supplementary 1)

A system comprising a processor,
wherein the processor is configured to
periodically acquire images of garments stored in a garment storage space by using an image acquisition device, and store the acquired images and attribute information associated with the images in a storage unit of an information processing apparatus,
perform preprocessing and classification processing on the stored images by using an image processing program and a machine learning program to extract feature information representing at least a type, a color, a pattern, a style, a quantity, a usage history, and a seasonality of the garments, and register the feature information as management information in the storage unit,
generate, in a natural language, a prompt sentence to be input to a generative AI model on the basis of at least a part of the management information and at least one of user attribute information, usage history information, emotion state information, environmental information, and external transaction information, the prompt sentence instructing the generative AI model to perform at least one of proposing a combination of garments, proposing missing garments, selecting candidates for acquisition of garments, and performing unnecessary-garment organization and generation of listing information for a market, and input the prompt sentence to the generative AI model,
analyze natural language data output from the generative AI model to generate structured data including at least one of coordination proposal information, acquisition candidate information, and listing information, update a garment management database on the basis of the structured data, and automatically execute at least one of product searching, product comparison, purchasing processing, and listing processing through a communication interface with an external transaction platform,
and transmit at least one of the coordination proposal information, the acquisition candidate information, and the listing information to a terminal device, display the information via a user interface on the terminal device, receive approval input or correction input from a user via the user interface, and reflect a result of the input in the garment management database and in conditions for generating the prompt sentence to be input to the generative AI model.

### (Supplementary 2)

The system according to supplementary 1,
wherein the processor is configured to
generate the prompt sentence so as to instruct the generative AI model to perform at least one of proposing a combination of garments, proposing missing garments, selecting purchase candidates, and proposing unnecessary-garment organization in accordance with an emotion state of a user on the basis of the emotion state information of the user, and execute garment management processing adapted to the emotion state of the user on the basis of an output result from the generative AI model.

### (Supplementary 3)

The system according to supplementary 1,
wherein the processor is configured to
identify garments that have been unused for a predetermined period as unnecessary-garment candidates on the basis of the management information including the usage history and the seasonality of the garments, generate the prompt sentence so as to instruct the generative AI model to generate listing information including at least a listing title, a listing description, and a recommended price for each of the unnecessary-garment candidates for registration in a transaction market, and execute automatic listing processing to the external transaction platform on the basis of the listing information output from the generative AI model.

What is claimed is:

1. A system comprising:
circuitry configured to communicate, via a communication interface coupled to a packet-switched network, with a terminal device, the circuitry being further configured to:
receive, from the terminal device via the communication interface, image data acquired by an image acquisition device of the terminal device;
store the received image data in a storage device;
execute a classification neural network on the stored image data to extract feature information representing attributes of objects depicted in the image data;
generate, based on the extracted feature information, a prompt sentence for instructing a generative neural network model to generate inference data comprising a proposal for combining a plurality of the objects based on the extracted feature information;
input the prompt sentence to the generative neural network model to acquire the inference data;
convert the inference data into structured output data associating the inference data with the feature information; and
transmit the structured output data to the terminal device via the communication interface for presentation on the terminal device.

2. The system according to claim 1, wherein the circuitry is further configured to execute preprocessing on the stored image data prior to executing the classification neural network, the preprocessing comprising at least one of resizing the image data to a predetermined resolution, normalizing pixel values of the image data, and segmenting foreground regions from background regions of the image data.

3. The system according to claim 2, wherein the classification neural network comprises a convolutional neural network including a plurality of convolutional layers, a plurality of pooling layers, and at least one fully connected layer, and wherein the circuitry is configured to apply a probability function to an output of the at least one fully connected layer to generate probability distributions over a plurality of attribute categories.

4. The system according to claim 3, wherein the plurality of attribute categories include a type of wearable article, a color, a pattern, and a style, and wherein the circuitry is configured to map the probability distributions to discrete attribute labels and to register the discrete attribute labels as management data records in the storage device.

5. The system according to claim 1, wherein the circuitry is further configured to acquire contextual data from at least one external information processing apparatus via the packet-switched network, and to incorporate the contextual data into the prompt sentence.

6. The system according to claim 5, wherein the contextual data comprises at least one of environmental condition data acquired from a first external information processing apparatus and schedule data acquired from a second external information processing apparatus.

7. The system according to claim 6, wherein the circuitry is configured to filter the feature information based on the contextual data by excluding items whose attribute values do not satisfy a condition derived from the environmental condition data or the schedule data, and to generate the prompt sentence based on the filtered feature information.

8. The system according to claim 7, wherein the environmental condition data comprises weather information including at least a temperature value and a precipitation probability, and wherein the schedule data comprises event information including at least a date, a time, and an event type, and wherein the circuitry is configured to generate the prompt sentence describing the filtered feature information, the weather information, and the event information as natural language text.

9. The system according to claim 1, wherein the circuitry is further configured to receive, from the terminal device via the communication interface, selection result data indicating acceptance or rejection of at least a portion of the structured output data, and to store the selection result data as history information in the storage device.

10. The system according to claim 9, wherein the circuitry is further configured to execute a learning process that updates at least one parameter used in generating the prompt sentence based on the history information, thereby modifying the prompt sentence for a subsequent invocation of the generative neural network model.

11. The system according to claim 10, wherein the circuitry is configured to compute, for each item represented in the feature information, an evaluation value indicating a preference degree of a user based on the history information, and to incorporate the evaluation value into the prompt sentence for a subsequent invocation of the generative neural network model.

12. The system according to claim 1, wherein the circuitry is further configured to calculate, for each item represented in the feature information, a usage status index based on at least one of a usage frequency metric and an elapsed time metric derived from the history information stored in the storage device.

13. The system according to claim 12, wherein the circuitry is configured to extract, as candidate items, items for which the usage status index satisfies a predetermined threshold condition, and to generate a second prompt sentence describing attribute data of the candidate items for input to the generative neural network model.

14. The system according to claim 13, wherein the circuitry is configured to acquire, from the generative neural network model in response to the second prompt sentence, listing data comprising at least a title, a description, and a recommended price for each candidate item, and to transmit the listing data to a transaction processing apparatus via the packet-switched network for registration on an electronic marketplace.

15. The system according to claim 1, wherein the generative neural network model comprises a transformer-based neural network including an embedding layer, a plurality of self-attention layers, a plurality of feed-forward layers, and a language modeling head, and wherein the circuitry is configured to tokenize the prompt sentence into a sequence of tokens, convert the tokens into embedding vectors, process the embedding vectors through the plurality of self-attention layers, and generate the inference data by autoregressive token generation.

16. The system according to claim 15, wherein the circuitry is configured to parse the inference data to extract individual proposal entries, match descriptive phrases in each proposal entry to corresponding attribute labels in the feature information stored in the storage device, and construct the structured output data by associating each proposal entry with item identifiers.

17. The system according to claim 11, wherein the objects depicted in the image data comprise articles of clothing, wherein the proposal comprises an outfit combination recommendation, and wherein the circuitry is further configured to estimate an emotion state of the user based on input data acquired from the terminal device, and to incorporate the emotion state into the prompt sentence to instruct the generative neural network model to generate the outfit combination recommendation adapted to the emotion state.

18. A system comprising:
circuitry configured to communicate, via a communication interface coupled to a packet-switched network, with a terminal device, the circuitry being further configured to:
receive, from the terminal device via the communication interface, image data acquired by an image acquisition device of the terminal device;
store the received image data in a storage device;
execute a convolutional neural network on the stored image data to extract feature information representing a type, a color, a pattern, and a style of objects depicted in the image data;
acquire contextual data comprising environmental condition data and schedule data from at least one external information processing apparatus via the packet-switched network;
filter the feature information based on the contextual data;
generate, based on the filtered feature information and the contextual data, a prompt sentence for instructing a generative neural network model to generate, in natural language, a proposal for combining a plurality of the objects;
input the prompt sentence to the generative neural network model to acquire inference data;
parse the inference data to associate proposal entries in the inference data with item identifiers corresponding to the feature information stored in the storage device, and convert the inference data into structured output data;
transmit the structured output data to the terminal device via the communication interface;
receive, from the terminal device, selection result data indicating acceptance or rejection of at least a portion of the structured output data; and
store the selection result data as history information in the storage device and execute a learning process that updates at least one parameter used in generating the prompt sentence based on the history information.

19. The system according to claim 18, wherein the circuitry is further configured to calculate, for each item represented in the feature information, a usage status index based on the history information, to extract candidate items for which the usage status index satisfies a predetermined threshold condition, and to generate a second prompt sentence for input to the generative neural network model to acquire listing data for registration of the candidate items on an electronic marketplace via the packet-switched network.

20. A method performed by circuitry configured to communicate, via a communication interface coupled to a packet-switched network, with a terminal device, the method comprising:
receiving, from the terminal device via the communication interface, image data acquired by an image acquisition device of the terminal device;
storing the received image data in a storage device;
executing a classification neural network on the stored image data to extract feature information representing attributes of objects depicted in the image data;
generating, based on the extracted feature information, a prompt sentence for instructing a generative neural network model to generate inference data comprising a proposal for combining a plurality of the objects based on the extracted feature information;
inputting the prompt sentence to the generative neural network model to acquire the inference data;
converting the inference data into structured output data associating the inference data with the feature information; and
transmitting the structured output data to the terminal device via the communication interface for presentation on the terminal device.
